(19) United States
(12) Patent Application Publication
(10) Pub. No.: US 2026/0249617 A1
(43) Pub. Date: Aug. 27, 2026

(54) Recording Method And Recording Device

(71) Applicant: SEIKO EPSON CORPORATION, Tokyo (JP)

(72) Inventors: Yuto ARAI, Shiojiri (JP); Keigo ANDO, Matsumoto (JP)

(21) Appl. No.: 19/549,226

(22) Filed: Feb. 25, 2026

(30) Foreign Application Priority Data
Feb. 26, 2025 (JP) 2025-029070

(51) Int. Cl. B41J 2/21; C09D 11/322; C09D 11/54

(52) U.S. Cl. CPC B41J 2/2117; C09D 11/322; C09D 11/54

(57) ABSTRACT

A recording method of recording on a recording medium using an aqueous white ink composition containing a white color material and an aqueous non-white ink composition containing a non-white color material, the recording method includes a white ink adhesion step of ejecting the white ink composition from an ink jet head to adhere the white ink composition to the recording medium, a drying step of drying the white ink composition adhered to the recording medium, and a non-white ink adhesion step of ejecting the non-white ink composition from an ink jet head to adhere the non-white ink composition to the recording medium, in which the non-white ink composition is adhered to the white ink composition dried in the drying step in an overlaid manner, the recording medium is a low-absorptive recording medium or a non-absorptive recording medium, the white ink adhesion step is performed by main scanning in which a relative position between the ink jet head and the recording medium is moved, the non-white ink adhesion step is performed by main scanning in which a relative position between the ink jet head and the recording medium is moved, after the main scanning of the white ink adhesion step, and the white ink composition contains a silicone-based surfactant A in which a surface tension of an aqueous solution with 0.1% by mass of the surfactant is 28.0 mN/m or less and a surface tension of a propylene glycol solution with 0.1% by mass of the surfactant is 28.0 mN/m or less.

The present application is based on, and claims priority from JP Application Serial Number 2025-029070, filed Feb. 26, 2025, the disclosure of which is hereby incorporated by reference herein in its entirety.

### BACKGROUND

### 1. Technical Field

The present disclosure relates to a recording method and a recording device.

### 2. Related Art

An ink jet recording method enables recording of high-definition images with a relatively simple device and is developing rapidly in various fields. Among these, in order to obtain favorable visibility of a color image (non-white image) even when recording on a recording medium such as a transparent film, stacking and applying a white ink composition (hereinafter, also referred to as “white ink composition”) and a non-white ink composition (hereinafter, also referred to as “color ink”) is performed.

For example, JP-A-2019-167518 discloses an ink jet recording method in which a white ink composition and a non-white ink composition are overlaid and adhered to a low-absorptive recording medium or a non-absorptive recording medium.

However, when main scanning of adhering the white ink composition and then main scanning of adhering the non-white ink composition to the white ink composition in an overlaid manner are performed and a non-white ink composition image is recorded on a white ink composition layer, it is difficult to suppress occurrence of unevenness of the image formed by the non-white ink composition with ensured image quality of an image formed by the white ink composition.

### SUMMARY

According to an aspect of the present disclosure, there is provided a recording method of recording on a recording medium using an aqueous white ink composition containing a white color material and an aqueous non-white ink composition containing a non-white color material, the recording method including: a white ink adhesion step of ejecting the white ink composition from an ink jet head to adhere the white ink composition to the recording medium; a drying step of drying the white ink composition adhered to the recording medium; and a non-white ink adhesion step of ejecting the non-white ink composition from an ink jet head to adhere the non-white ink composition to the recording medium, in which the non-white ink composition is adhered to the white ink composition dried in the drying step in an overlaid manner, the recording medium is a low-absorptive recording medium or a non-absorptive recording medium, the white ink adhesion step is performed by main scanning in which a relative position between the ink jet head and the recording medium is moved, the non-white ink adhesion step is performed by main scanning in which a relative position between the ink jet head and the recording medium is moved, after the main scanning of the white ink adhesion step, and the white ink composition contains a silicone-based surfactant A in which a surface tension of an aqueous solution with 0.1% by mass of the surfactant is 28.0 mN/m or less and a surface tension of a propylene glycol solution with 0.1% by mass of the surfactant is 28.0 mN/m or less.

According to an aspect of the present disclosure, there is provided a recording device configured to perform the above-described recording method, the recording device including: the white ink composition; the non-white ink composition; the ink jet head configured to perform the white ink adhesion step; a drying mechanism configured to perform the drying step; and the ink jet head configured to perform the non-white ink adhesion step.

### BRIEF DESCRIPTION OF THE DRAWINGS

FIG. 1 is a schematic cross-sectional view schematically illustrating an ink jet recording device.

FIG. 2 is a perspective view illustrating an example of a configuration around a carriage of the ink jet recording device.

FIG. 3 is Table 1 showing formulations of a white ink composition and a non-white ink composition.

FIG. 4 is Table 2 showing a formulation of a treatment liquid.

FIG. 5 is Table 3 showing conditions and evaluation results of Examples.

FIG. 6 is Table 4 showing conditions and evaluation results of Examples.

FIG. 7 is Table 5 showing conditions and evaluation results of Examples, Comparative Examples, and Reference Example.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

In the present specification, “(meth)acrylic” means acrylic or methacrylic, and “(meth)acrylate” means acrylate or methacrylate.

### 1. Recording Method

The recording method according to the present embodiment is a recording method of recording on a recording medium using an aqueous white ink composition containing a white color material and an aqueous non-white ink composition containing a non-white color material.

The recording method according to the present embodiment includes a white ink adhesion step of ejecting the white ink composition from an ink jet head to adhere the white ink composition to the recording medium, a drying step of drying the white ink composition adhered to the recording medium, and a non-white ink adhesion step of ejecting the non-white ink composition from an ink jet head to adhere the non-white ink composition to the recording medium.

In the recording method according to the present embodiment, the non-white ink composition is adhered to the white ink composition dried in the drying step in an overlaid manner, the recording medium is a low-absorptive recording medium or a non-absorptive recording medium, the white ink adhesion step is performed by main scanning in which a relative position between the ink jet head and the recording medium is moved, the non-white ink adhesion step is performed by main scanning in which a relative position between the ink jet head and the recording medium is moved, after the main scanning of the white ink adhesion step.

The white ink composition used in the recording method according to the present embodiment contains a silicone-based surfactant A in which a surface tension of an aqueous solution with 0.1% by mass of the surfactant is 28.0 mN/m or less and a surface tension of a propylene glycol solution with 0.1% by mass of the surfactant is 28.0 mN/m or less.

### 1.1. White Ink Adhesion Step

In the white ink adhesion step, the white ink composition is ejected from an ink jet head and adhered to the recording medium.

### 1.1.1. White Ink Composition

The white ink composition is an aqueous composition containing a white color material. In addition, the white ink composition contains a silicone-based surfactant A in which a surface tension of an aqueous solution with 0.1% by mass of the surfactant is 28.0 mN/m or less and a surface tension of a propylene glycol solution with 0.1% by mass of the surfactant is 28.0 mN/m or less. 1.1.1. (1) White color material

The white ink composition contains a white color material. Examples of the white color material include C. I. Pigment White 1 that is basic lead carbonate, C. I. Pigment White 4 made of zinc oxide, C. I. Pigment White 5 made of a mixture of zinc sulfide and barium sulfate, C. I. Pigment White 6 made of titanium dioxide, C. I. Pigment White 6:1 made of titanium dioxide containing other metal oxides, C. I. Pigment White 7 made of zinc sulfide, C. I. Pigment White 18 made of calcium carbonate, C. I. Pigment White 19 made of clay, C. I. Pigment White 20 made of mica titanium, C. I. Pigment White 21 made of barium sulfate, C. I. Pigment White 22 made of gypsum, C. I. Pigment White 26 made of magnesium oxide and silicon dioxide, C. I. Pigment White 27 made of silicon dioxide, C. I. Pigment White 28 made of anhydrous calcium silicate, and the like. Among these, C. I. Pigment White 6 which is excellent in color development properties, masking properties, and the like is preferably used. In addition, particles having a hollow structure may be used as the white color material, and known particles can be used, as the particles having a hollow structure.

A volume average particle diameter of the white color material is preferably 30 nm or more and 500 nm or less, more preferably 50 nm or more and 450 nm or less, and still more preferably 200 nm or more and 400 nm or less. By setting the volume average particle diameter of the white color material in this range, there is a tendency that ejection stability from an ink jet head can be ensured. In addition, there is a tendency that the masking properties can be improved.

In the present specification, the “volume average particle diameter” refers to a volume-based particle size distribution that is a particle diameter at 50% by volume cumulative distribution, unless otherwise specified. The volume average particle diameter is measured by a dynamic light scattering method or a laser diffraction light method described in JIS Z8825. Specifically, a particle size analyzer (for example, “Microtrac UPA” manufactured by Nikkiso Co., Ltd.) using the dynamic light scattering method as a measurement principle can be used.

In the present specification, the term “white” when referring to a white ink composition, a white color material, and the like does not mean only completely white, but as long as the color is in a range of being visually recognized as white, the white includes color that is colored with chromatic color or achromatic color, or color having glossiness. In addition, the name of the ink or color material includes those that suggest that the ink or color material is white and those that are named and sold.

More quantitatively, the “white” in a recorded matter includes not only a color in which L* is 100, but also a color in which L* is 60 or more and 100 or less and a* and b* each are ±10 or less, in CIELAB, for example.

More specifically, when lightness (L*) and chromaticity (a*, b*) of a recording portion of a recorded matter are measured using a CIELAB-compliant spectrophotometer when recording is performed in such an amount that a surface of a recording medium made of a transparent film is sufficiently covered with the ink, the white ink composition preferably falls within the above range. The recorded matter recorded in a sufficiently covered amount is, for example, an adhesion amount of 15 mg/inch². More preferably, 80≤L*≤100, −4.5≤a*≤2, and −10≤b*≤2.5. Examples of the recording medium made of a transparent film include LAG Jet E-1000ZC (manufactured by LINTEC Corporation). Examples of the CIELAB-compliant spectrophotometer include SPECTROLINO (product name, manufactured by GretagMacbeth), in which measurement is performed by setting measurement conditions as D50 light source, observation field as 2°, concentration as DIN NB, white standard as Abs, filter as No, and measurement mode as Reflectance. In addition, a color other than “white” is referred to as “non-white”.

A content of the white color material is preferably 18 by mass or more and 30% by mass or less, more preferably 5% by mass or more and 25% by mass or less, still more preferably 10% by mass or more and 20% by mass or less, particularly preferably 10% by mass or more and 15% by mass or less, and more particularly preferably 108 by mass or more and 12% by mass or less with respect to the total amount of the white ink composition. When the content of the white color material is within the above-described range, rubbing fastness tends to be further improved, background hiding properties of the image formed by the white ink composition tend to be further improved, and more favorable color developing properties (whiteness) can be obtained.

In order to enhance the dispersibility of the white color material in the ink composition, it is preferable to perform a surface treatment on the color material or to blend a dispersant or the like.

A surface treatment of the white color material is preferably a treatment to directly or indirectly bond a carbonyl group, a carboxyl group, an aldehyde group, a hydroxyl group, a sulfone group, an ammonium group, a functional group formed of salts thereof, or the like to a surface of the color material by physical or chemical treatment. In particular, the surface treatment is more preferably a treatment in which the surface of the color material is oxidized or sulfonated with, for example, ozone, hypochlorous acid, fuming sulfuric acid, or the like to modify the surface of the color material.

When a dispersant is blended in the white ink composition, a dispersant having a hydrophobic portion (hydrophobic group) and a hydrophilic portion (hydrophilic group) in the molecular structure are preferably used. In such a dispersant, the hydrophobic portion has an action of being adsorbed on a particle surface of the color material, and the hydrophilic portion has an action of being oriented on an aqueous medium side of the ink composition. Due to the action, there is a tendency that the color material can be more stably contained in the ink composition as a dispersant.

Such a dispersant is not particularly limited, and examples thereof include styrene-acrylic resin such as an acrylic resin, a styrene-(meth)acrylic acid copolymer, and a styrene-(meth)acrylic acid-(meth)acrylate copolymer, a styrene-maleic acid-based resin, salts thereof, formalin condensates of aromatic sulfonate, and the like; and one or more selected from these groups can be adopted. A commercially available product may be used as the dispersant.

When the white color material is dispersed by a dispersant, a ratio of the white color material to the dispersant is preferably 10:1 to 1:10, and more preferably 4:1 to 1:3.

In addition, a method of coating the particles of the white color material with a resin or the like to impart dispersibility may be used. As a method of coating the white color material, an acid precipitation method, a phase inversion emulsification method, a mini-emulsion polymerization method, and the like can be adopted.

### 1.1.1. (2) Silicone-Based Surfactant A

The white ink composition contains a silicone-based surfactant A. In the silicone-based surfactant A, a surface tension of an aqueous solution with 0.1% by mass of the surfactant is 28.0 mN/m or less, and a surface tension of a propylene glycol solution with 0.18 by mass of the surfactant is 28.0 mN/m or less.

In the present specification, the condition that the surface tension of an aqueous solution with 0.18 by mass of the surfactant is 28.0 mN/m or less and the surface tension of a propylene glycol solution with 0.18 by mass of the surfactant is 28.0 mN/m or less may be referred to as “condition (a)”. In addition, the surface tension in the condition (a) is a value at 25° C. The surface tension may be measured in the same manner as the surface tension of the white ink composition, which will be described later.

As the silicone-based surfactant A satisfying the condition (a), an aqueous solution with 0.1% by mass of the silicone-based surfactant and a propylene glycol solution with 0.1% by mass of the silicone-based surfactant are adjusted, the surface tension thereof is measured, and it is checked whether or not the condition (a) is satisfied. In this way, the silicone-based surfactant A may be prepared.

Examples of the silicone-based surfactant A in which the surface tension of an aqueous solution with 0.1% by mass of the surfactant is 28.0 mN/m or less and the surface tension of a propylene glycol solution with 0.1% by mass of the surfactant is 28.0 mN/m or less include BYK-3420 and BYK-3480 (product names, manufactured by BYK Japan KK.).

The surface tension of an aqueous solution with 0.1% by mass of the silicone-based surfactant A is preferably 20.0 to 28.0 mN/m, more preferably 21.0 to 27.0 mN/m, and still more preferably 22.0 to 26.0 mN/m.

The surface tension of a propylene glycol solution with 0.1% by mass of the silicone-based surfactant A is preferably 20.0 to 28.0 mN/m, more preferably 23.0 to 27.5 mN/m, and still more preferably 25.0 to 27.3 mN/m.

When the white ink composition is landed on the recording medium by the white ink adhesion step and the drying has not progressed, the drying of the white ink composition has not progressed, and thus a large amount of water remains. On the other hand, when the drying has progressed after the landing of the white ink composition, the drying of the water of the white ink composition progresses, and thus a large amount of the organic solvent remains. This is because the organic solvent having a standard boiling point higher than that of water is used in order to impart moisturizing properties to the white ink composition.

In addition, it is found that the surface tension of the white ink composition when being in contact with the non-white ink affects wettability of ink droplets of the non-white ink composition when being in contact with the white ink composition.

It is considered that the surface tension of the aqueous solution with 0.1% by mass of the surfactant is related to a surface tension of the white ink composition in a state in which the drying has not progressed after the landing of the white ink composition; and the surface tension of the propylene glycol solution with 0.1% by mass of the surfactant is related to a surface tension of the white ink composition in a state in which the drying has progressed after the landing of the white ink composition.

Therefore, by containing the silicone-based surfactant A satisfying the condition (a), both the ink droplets of the non-white ink in contact with the white ink composition in a state in which the drying has not progressed after the landing of the white ink composition on the recording medium and the ink droplets of the non-white ink in contact with the white ink composition in a state in which the drying has progressed after the landing of the white ink composition on the recording medium have similar wettability of the ink droplets, and thus the unevenness of the obtained image of the non-white ink can be reduced.

It is considered that, when the white ink composition does not contain the surfactant satisfying the condition (a), the wettability of the ink droplets of the non-white ink in contact with the white ink composition in a state in which the drying has not progressed after the landing of the white ink composition and the wettability of the ink droplets of the non-white ink in contact with the white ink composition in a state in which the drying has progressed after the landing of the white ink composition are not close to each other, and there are ink droplets having large wettability and ink droplets having small wettability in the image, which results in the unevenness of the image of the non-white ink being conspicuous.

It is presumed that, when there is a variation in a surface temperature of the recording medium, a wind speed, or a wind temperature used for drying the white ink composition in the drying step, a degree of drying of the white ink composition varies depending on a position of the recording medium, and a state in which the drying of the white ink composition has not progressed or a state in which the drying of the white ink composition has progressed occurs. In addition, it is presumed that, even when the time from the adhesion of the white ink composition to the recording medium to the overlapping adhesion of the non-white ink composition varies depending on the position of the recording medium, the degree of drying of the white ink composition at the time of overlapping adhesion of the non-white ink composition varies, and a state in which the drying of the white ink composition has not progressed or a state in which the drying of the white ink composition has progressed occurs.

It is presumed that, in the silicone-based surfactant A satisfying the condition (a), the balance between hydrophilicity and hydrophobicity is favorable, and thus surface activity in the aqueous solution and surface activity in the propylene glycol solution are both excellent, and as a result, the condition (a) is satisfied.

A content of the silicone-based surfactant A in the white ink composition is preferably 0.05% by mass or more and 2% by mass or less, more preferably 0.18 by mass or more and 1.5% by mass or less, and still more preferably 0.2% by mass or more and 1% by mass or less. The content thereof is still more preferably 0.5% by mass or more and 0.8% by mass or less. When the content of the silicone-based surfactant A in the white ink composition is within such a range, graininess and filled pinholes of the obtained image and abrasion resistance can be further improved.

The silicone-based surfactant A may be a silicone-based surfactant represented by Formula (1), and is preferably such a silicone-based surfactant. When such a silicone-based surfactant is used, it is easy to satisfy the condition (a). Since the silicone-based surfactant represented by General Formula (1) has a structure of both terminal modification, the balance between hydrophilicity and hydrophobicity can be adjusted by adjusting a length of a main skeleton having a siloxane bond, other than a polyether-modified group portion. Accordingly, it is easy to satisfy the condition (a).

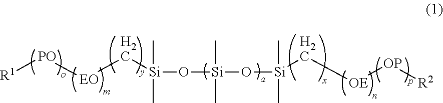

(in the formula, a is an integer of 7 to 50, x and y are each independently an integer of 1 to 4, m and n are each independently an integer of 1 to 20, o and p are each independently an integer of 0 to 20, m+n is 2 to 40, o+p is 0 to 40, and R¹ and R² are each independently selected from the group consisting of a hydrogen atom, a hydroxy group, an alkyl group having 1 to 6 carbon atoms, and a (meth)acrylic group, E is an ethylene group and P is a propylene group, and the order between the OE (EO) unit and the OP (PO) unit is not specified)

In Formula (1),
a is an integer of 7 to 50, preferably 8 to 48, more preferably 9 to 45, still more preferably 10 to 40, even more preferably 11 to 30, and particularly preferably 11 to 20.
x and y are each independently an integer of 1 to 4, preferably 1 to 3, and more preferably 2 to 3.
m and n are each independently an integer of 1 to 20, preferably 2 to 15, more preferably 4 to 10, and still more preferably 5 to 8.
o and p are each independently an integer of 0 to 20, preferably 0 to 10, more preferably 0 to 5, still more preferably 0 to 3, particularly preferably 0 to 1, and more particularly preferably 0.
m+n is 2 to 40, preferably 4 to 30, more preferably 8 to 20, and still more preferably 10 to 15.
o+p is 0 to 40, preferably 0 to 20, more preferably 0 to 10, still more preferably 0 to 3, particularly preferably 0 to 1, and more particularly preferably 0.
R¹ and R² are each independently selected from the group consisting of a hydrogen atom, a hydroxy group, an alkyl group having 1 to 6 carbon atoms, and a (meth)acrylic group, and are preferably a hydroxy group. The order between the OE (EO) unit and the OP (PO) unit is not specified, that is, when each of the OE (EO) unit and the OP (PO) unit has one or more, the order is not specified in units of one OE (EO) and one OP (PO).
P is a propylene group, and examples thereof include a 1,2-propylene group and a 1,3-propylene group, and a 1,2-propylene group is preferable.

The silicone-based surfactant A may be a silicone-based surfactant represented by Formula (2), and is preferably such a silicone-based surfactant.

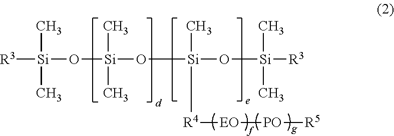

(in the formula, R³'s each independently represent an alkyl group having 1 to 6 carbon atoms, R⁴ represents an alkylene group having 1 to 4 carbon atoms, R⁵ represents a group selected from the group consisting of a hydrogen atom, a hydroxy group, an alkyl group having 1 to 6 carbon atoms, and a (meth)acrylic group, EO represents an ethylene oxide group, PO represents a propylene oxide group, the order between EO units and PO units is not specified, d and e are integers of 1 or more, d+e represents an integer of 2 to 10, f is an integer of 1 to 20, and g is an integer of 0 to 20)

In Formula (2),
d+e is an integer of 2 to 10, preferably 3 to 8, and more preferably 3 to 6. d and e are preferably each half of d+e.
R⁴ is an alkylene group having 1 to 4 carbon atoms, preferably having 1 to 3 carbon atoms, and more preferably having 2 or 3 carbon atoms.
f is an integer of 1 to 20, preferably 2 to 15, more preferably 4 to 10, and still more preferably 5 to 8.
g is an integer of 0 to 20, preferably 0 to 10, more preferably 0 to 5, still more preferably 0 to 3, particularly preferably 0 to 1, and more particularly preferably 0.
R⁵ is selected from the group consisting of a hydrogen atom, a hydroxy group, an alkyl group having 1 to 6 carbon atoms, and a (meth)acrylic group, and is preferably a hydroxy group.

The silicone-based surfactant A may be obtained by synthesis. For example, the synthesis can be performed by an addition reaction of a silicone oil having an Si—H structure and a polyether having a carbon-carbon double bond at the terminal. The addition reaction for synthesis may be performed using a Pt-based catalyst or the like. As the silicone oil having an Si—H structure, a compound in which, in the compound of Formula (1) or Formula (2), the polyether-modified group of the Si atom to which the polyether-modified group is bonded is substituted with a hydrogen atom may be used; and as the polyether having a carbon-carbon double bond at a terminal, a compound in which the Si atom of the carbon atom bonded to the Si atom of the polyether-modified group in the polyether-modified group portion of Formula (1) or Formula (2) is substituted with a carbon-carbon double bond may be used.

In addition, in the silicone-based surfactant A, it is preferable that the maximum peak in a molecular weight range of 300 or more in a molecular weight distribution in gel permeation chromatography (GPC) is in a molecular weight range of 1,000 to 4,500. When the molecular weight of the silicone-based surfactant A is within the range, the abrasion resistance of the obtained image can be further improved.

In addition, when the silicone-based surfactant has a molecular weight in the above-described range, the surfactant easily satisfies the above-described condition (a), which is preferable. For example, it is presumed that, since the size of the surfactant molecule also relates to ease of association or arrangement of surfactant molecules in a solution, when the silicone-based surfactant has a molecular weight in the above-described range, the ease of association or arrangement of the surfactant molecules in an aqueous solution and the ease of association or arrangement of the surfactant molecules in a propylene glycol solution are the same, and thus the condition (a) is easily satisfied. However, this is merely a presumption, and the reason is not limited thereto.

The maximum peak in the molecular weight range of 300 or more in the molecular weight distribution in gel permeation chromatography is more preferably in a molecular weight range of 1, 500 to 4,000. Furthermore, the above-described maximum peak is still more preferably in a molecular weight range of 1,550 to 3,000, and even more preferably in a molecular weight range of 1,600 to 2,500.

The maximum peak in the molecular weight range of 300 or more of the silicone-based surfactant can be specified from a chart of the molecular weight distribution in GPC obtained by using the horizontal axis as the “logarithmic value of molecular weight M (Log M)” and the vertical axis as the “differential value (dw/d (Log M)) of the concentration fraction”. In addition, the term “maximum peak” means the maximum peak (mountain) in the molecular weight range of 300 or more. In addition, the “maximum peak in the molecular weight range of 300 or more” means that the peak having a molecular weight of less than 300 is ignored. That is, the maximum peak may be present at a molecular weight of less than 300, but is the maximum peak when viewed in the molecular weight range of 300 or more.

Although not particularly limited, for example, the measurement conditions in the GPC measurement in the present embodiment can be the conditions described in Examples, and the specific determination of the molecular weight can be performed using standard polystyrene.

The white ink composition may further contain a silicone-based surfactant other than the silicone-based surfactant A, that is, a silicone-based surfactant that does not satisfy the condition (a). Examples of such a silicone-based surfactant include BYK-306, BYK-307, BYK-333, BYK-341, BYK-345, BYK-346, BYK-348, and BYK-349 (all product names, manufactured by BYK Japan KK.); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all product names, manufactured by Shin-Etsu Chemical Co., Ltd.); and Silface SAG002, 005, 503A, and 008 (all product names, manufactured by Nissin Chemical co., ltd.).

When the white ink composition contains the silicone-based surfactant that does not satisfy the condition (a), it is preferable that a content thereof is a content that does not inhibit the action of the silicone-based surfactant satisfying the above-described condition (a).

### 1.1.1. (3) Water

The white ink composition is an aqueous ink jet ink. The “aqueous” means that at least water is contained as a solvent component, and water may be contained as a main solvent component. The “ink jet ink” refers to an ink composition ejected from an ink jet head by an ink jet method and used for recording.

Examples of the water include pure water such as ion-exchanged water, ultrafiltration water, reverse osmosis water, and distilled water, water having reduced ionic impurities such as ultrapure water, and the like. In addition, when water sterilized by ultraviolet irradiation or addition of hydrogen peroxide or the like is used, the generation of bacteria or fungi can be suppressed when the white ink composition is stored for a long period of time.

A content of water is preferably 50% by mass or more, and more preferably 50% to 100% by mass in a liquid medium component. Furthermore, the content thereof is preferably 60% to 90% by mass, and more preferably 70% to 80% by mass. Here, the liquid medium is a solvent component such as water and an organic solvent.

In addition, the content of water is preferably 30% by mass or more, more preferably 40% by mass or more, and even more preferably 50% by mass or more with respect to the total mass of the white ink composition. The upper limit of the water content is not particularly limited, but is, for example, preferably 998 by mass or less, more preferably 90% by mass or less, 80% by mass or less, 70% by mass or less, and 60% by mass or less with respect to the total mass of the white ink composition.

### 1.1.1. (4) Organic Solvent

The white ink composition may contain an organic solvent. When the ink composition contains an organic solvent, there is a tendency that the wet spreadability of the ink can be made more favorable, the embedment of the white ink composition on the recording medium can be made more favorable, and as a result, the occurrence of unevenness of color image can be reduced.

Examples of the organic solvent include esters, alkylene glycol ethers, cyclic esters, amides, alcohols, polyhydric alcohols, and the like.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters such as ethylene glycol diacetate, diethylene glycol diacetate, propylene glycol diacetate, dipropylene glycol diacetate, propionate ethylene glycol acetate, butyrate ethylene glycol acetate, butyrate diethylene glycol acetate, propionate diethylene glycol acetate, butyrate diethylene glycol acetate, propionate propylene glycol acetate, butyrate propylene glycol acetate, butyrate dipropylene glycol acetate, and propionate dipropylene glycol acetate.

The alkylene glycol ethers may be alkylene glycol monoethers or diethers, and are preferably alkyl ethers. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether; and the like.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; compounds in which a hydrogen of a methylene group adjacent to a carbonyl group thereof is substituted with an alkyl group having 1 to 4 carbon atoms, and the like.

Examples of the amides include cyclic amides, acyclic amides, and the like. Examples of the acyclic amides include alkoxyalkylamides and the like.

Examples of the cyclic amides include lactams. Examples of lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl) pyrrolidin-2-one.

Examples of alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, 3-n-butoxy-N, N-methylethylpropionamide, 3-n-propoxy-N, N-dimethylpropionamide, 3-n-propoxy-N, N-diethylpropionamide, 3-n-propoxy-N, N-methylethylpropionamide, 3-iso-propoxy-N, N-dimethylpropionamide, 3-iso-propoxy-N, N-diethylpropionamide, 3-iso-propoxy-N, N-methylethylpropionamide, 3-tert-butoxy-N, N-dimethylpropionamide, 3-tert-butoxy-N, N-diethylpropionamide, 3-tert-butoxy-N, N-methylethylpropionamide, N, N-dimethylisobutyrate amide, and the like.

Examples of alcohols include a compound in which one hydrogen atom of alkane is substituted with a hydroxyl group. The alkane preferably has 10 or less carbon atoms, more preferably 6 or less carbon atoms, and still more preferably 3 or less carbon atoms. The number of carbon atoms of the alkane is 1 or more, and is preferably 2 or more. The alkane may be a linear type or a branched type. Examples of alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, phenoxy propanol, and the like.

Polyhydric alcohols have two or more hydroxyl groups in the molecule. Examples of polyhydric alcohols include alkanediols and polyols.

Examples of alkanediols include compounds in which alkane is substituted with two hydroxyl groups. Examples of alkanediols include 1,2-alkanediol, which is a general term for compounds in which hydroxyl groups are substituted at the first and second positions of alkanes, and other alkanediols other than 1,2-alkanediol.

Examples of the 1,2-alkanediol include ethylene glycol, 1,2-propanediol (propylene glycol), 1,2-butanediol (1,2BD), 1,2-pentanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2 -pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, 2-methyl-2-propyl-1,3-propanediol, and the like.

Among the alkanediols, alkanediols having 5 or more carbon atoms are preferable, and alkanediols having 5 to 10 carbon atoms are more preferable. Alternatively, alkanediol having 4 or less carbon atoms is preferable, and alkanediol having 2 to 3 carbon atoms is more preferable.

Examples of the polyols include a condensate in which two or more molecules of alkanediols are intermolecularly condensed between hydroxyl groups, a compound having three or more hydroxyl groups, and the like.

Examples of the condensate in which two or more molecules of alkanediols are intermolecularly condensed between hydroxyl groups include dialkylene glycol such as diethylene glycol and dipropylene glycol, trialkylene glycol such as triethylene glycol and tripropylene glycol, and the like.

A condensate in which two or more molecules of alkanediols having 4 or less carbon atoms are intermolecularly condensed with hydroxyl groups is preferable, and a condensate in which two or more molecules of alkanediols having 2 or 3 carbon atoms are intermolecularly condensed with hydroxyl groups is more preferable.

The compound having three or more hydroxyl groups is a compound having three or more hydroxyl groups having an alkane or polyether structure as a skeleton. Examples of the compound having three or more hydroxyl groups include glycerin, trimethylolethane, trimethylolpropane, 1,2,5-hexanetriol, 1,2,6-hexanetriol, pentaerythritol, polyoxypropylenetriol, and the like.

The organic solvent may be used alone or in combination of two or more thereof.

A content of the organic solvent is preferably 5% to 50% by mass, more preferably 5% to 40% by mass, still more preferably 10% to 30% by mass, and even more preferably 15% to 25% by mass with respect to the total amount of the white ink composition. It is also preferable that the content of the polyhydric alcohols is within the above-described range, and it is also preferable that the content of the alkanediols is within the above-described range.

In the white ink composition, a content of the organic solvent having a standard boiling point of higher than 280° C. is preferably 5% by mass or less, more preferably 3% by mass or less, still more preferably 1% by mass or less, particularly preferably 0.5% by mass or less, and particularly preferably 0% by mass (not contained), with respect to the total amount of the white ink composition. It is preferable because it has excellent white image quality and abrasion resistance.

On the other hand, it is also preferable to contain the organic solvent having a standard boiling point of higher than 280° C., and a content thereof is preferably 0.5% by mass or more, and more preferably 18 by mass or more. In this case, nozzle reliability and the like are excellent.

Examples of the organic solvent having a standard boiling point of higher than 280° C. include triethylene glycol, glycerin, and the like.

In addition, the white ink composition contains an organic solvent, and contains an organic solvent having a standard boiling point of 200° C. or lower in an amount of preferably 20% by mass or more, more preferably 30% by mass or more, and still more preferably 50% by mass or more, with respect to the total amount of the contained organic solvents. In this manner, the abrasion resistance of the white ink composition and the reduction of image unevenness can be further improved. This effect is particularly remarkable when the adhesion amount of the white ink composition is large. From the viewpoint of more excellent nozzle reliability and the like, the upper limit thereof is preferably 100% by mass or less, and more preferably 80% by mass or less.

Furthermore, the white ink composition contains an organic solvent, and a standard boiling point of an organic solvent having the highest standard boiling point among contained organic solvents is preferably 300° C. or lower, more preferably 290° C. or lower, and still more preferably 280° C. or lower. Furthermore, it is still more preferable to be 250° C. or lower. Furthermore, it is preferable to be 210° C. or lower.

In this manner, the abrasion resistance of the white ink composition can be further improved. This effect is particularly remarkable when the adhesion amount of the white ink composition is large.

The lower limit thereof is preferably 150° C. or higher, more preferably 160° C. or higher, and still more preferably 170° C. or higher. It is preferable from the viewpoint of nozzle reliability and the like.

### 1.1.1. (5) Other Components

### Resin Particles

The white ink composition may contain resin particles. The resin particles function as a so-called fixing resin that improves the adhesion property and scratch resistance of components of the ink adhered to the recording medium. The properties of the resin particles may be in the form of a powder, but an emulsion form is preferable.

Examples of the resin of resin particles include urethane-based resin, acrylic resin, fluorene-based resin, polyolefin-based resin, rosin-modified resin, terpene-based resin, polyester-based resin, polyamide-based resin, epoxy-based resin, vinyl chloride-based resin, ethylene vinyl acetate-based resin, vinyl acetate resin, butadiene resin, styrene resin, crosslinked acrylic resin, crosslinked styrene resin, benzoguanamine resin, phenol resin, silicone resin, epoxy resin, paraffin resin, fluororesin, and the like.

A urethane-based resin is a general term for a resin having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to a urethane bond, and the like may be used. The urethane-based resin may be a commercially available product. For example, the urethane-based resin may be selected from commercially available urethane-based resins such as SUPERFLEX 210, 460, 460s, 840, and E-4000 (product name, manufactured by DKS Co., Ltd.), RESAMINE D-1060, D-2020, D-4080, D-4200, D-6300, and D-6455 (product name, manufactured by Dainichiseika Color & Chemicals Mfg.), TAKELAC WS-6020, WS-6021, and W-512-A-6 (product name, manufactured by Mitsui Chemicals Polyurethanes), SANCURE 2710 (product name, manufactured by LUBRIZOL), and PERMARIN UA-150 (product name, manufactured by Sanyo Chemical Industries).

An acrylic resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. Examples thereof include an acrylic-vinyl-based resin which is a copolymer of an acrylic monomer and a vinyl-based monomer and the like. In addition, examples thereof include a copolymer with a vinyl-based monomer such as styrene. For example, a styrene acrylic resin can be exemplified. As the acrylic monomer, acrylamide, acrylonitrile, and the like can also be used.

The acrylic resin may be a commercially available product, and may be selected from, for example, FK-854 (product name, manufactured by Chuo Kagaku Kogyo Co., Ltd.), MOVINYL 6969D, 952B, 718A (product name, manufactured by Nippon Synthetic Chemical Industry Co., Ltd.), NIPOL LX852, LX874 (product name, manufactured by Nippon Zeon Corporation), POLYSOL AT860 (manufactured by Showa Denko K.K.), VONCOAT AN-1190S, YG-651, AC-501, AN-1170, 4001 (product name, manufactured by DIC Corporation, acrylic resin emulsion), and the like.

In addition, in the present specification, the acrylic resin may be a styrene acrylic resin as mentioned above.

The styrene acrylic resin is a copolymer obtained from a styrene monomer and an acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, and the like. The styrene acrylic resin may be a commercially available product, and examples thereof include JONCRYL 62J, 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (product name, manufactured by BASF), MOVINYL 966A, 975N (product name, manufactured by Nippon Synthetic Chemical Industry Co., Ltd.), and the like.

The vinyl chloride-based resin may be a vinyl chloride-vinyl acetate copolymer.

The polyolefin-based resin has an olefin such as ethylene, propylene, and butylene in the structural skeleton, and known ones can be appropriately selected and used. As the polyolefin-based resin, a commercially available product can be used, and for example, may be selected and used from ARROWBASE CB-1200, CD-1200 (product name, manufactured by Unitika Ltd.), HITEC E-6500 (product name, manufactured by Toho Chemical Industry Co., Ltd., polyethylene wax emulsion), SN-2002 (product name, manufactured by Toho Chemical Industry Co., Ltd., polyester resin emulsion), and the like.

In addition, examples of commercially available product of resin emulsion may be selected and used from MICROGEL E-1002 and E-5002 (product name manufactured by Nippon Paint Corporation, styrene-acrylic resin emulsion), VONCOAT AN-1190S, YG-651, AC-501, AN-1170, 4001, and 5454 (product name manufactured by DIC Corporation, styrene-acrylic resin emulsion), POLYSOL AM-710, AM-920, AM-2300, AP-4735, AT-860, and PSASE-4210E (acrylic resin emulsion), POLYSOL AP-7020 (styrene-acrylic resin emulsion), POLYSOL SH-502 (vinyl acetate resin emulsion), POLYSOL AD-13, AD-2, AD-10, AD-96, AD-17, and AD-70 (ethylene-vinyl acetate resin emulsion), POLYSOL PSASE-6010 (ethylene-vinyl acetate resin emulsion) (product name manufactured by Showa Denko product), POLYSOL SAE1014 (product name, styrene-acrylic resin emulsion, Nippon Zeon Corporation), SAIVINOL SK-200 (product name, an acrylic resin emulsion, Saiden Chemical Industry), AE-120A (product name manufactured by JSR, acrylic resin emulsion), AE373D (product name manufactured by Emulsion Technology, carboxy-modified styrene-acrylic resin emulsion), SEIKADYNE 1900 W (product name manufactured by Dainichiseika Color & Chemicals Mfg., ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid-acrylic resin emulsion), (product name manufactured by Nissin Chemical co., ltd.), VINYBLAN 700, 2586 (manufactured by Nissin Chemical co., ltd., ELITEL KA-5071S, KT-8803, KT-9204, KT-8701, KT-8904, and KT-0507 (product name manufactured by Unitika, polyester resin emulsion), HYTEC E-6500 (product name manufactured by Toho Chemical Industry Co., Ltd., polyester resin emulsion), SN-2002 (product name manufactured by Toho Chemical Industry Co., Ltd., polyester resin emulsion), TAKELAC W-6020, W-635, W-6061, W-605, W-635, and W-6021 (product name manufactured by Mitsui Chemicals Polyurethanes, urethane resin emulsion), SUPERFLEX 870, 800, 150, 420, 460, 470, 610, 620, and 700 (product name manufactured by DKS Co., Ltd., urethane resin emulsion), PERMARIN UA-150 (manufactured by Sanyo Chemical Industries, urethane resin emulsion), SANCURE 2710 (manufactured by Lubrizol Japan, urethane resin emulsion), NeoRez R-9660, R-9637, and R-940 (manufactured by Kusumoto Chemicals Ltd., urethane resin emulsion), ADEKA BONTIGHTER HUX-380 and 290K (manufactured by ADEKA Corporation, urethane resin emulsion), MOVINYL 966A and MOVINYL 7320 (manufactured by Japan Coating Resin), JONCRYL 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all manufactured by BASF), NK Binder R-5HN (manufactured by Shin-Nakamura Chemical Co., Ltd.), HYDRAN WLS-210 (non-crosslinked polyurethane, manufactured by DIC Corporation), and the like.

In addition, a glass transition temperature (Tg) of the resin particles is preferably 50° C. or higher, more preferably 60° C. or higher, and still more preferably 70° C. or higher. On the other hand, the temperature is preferably 120° C. or lower, more preferably 100° C. or lower, still more preferably 90° C. or lower, and particularly preferably 80° C. or lower. When the glass transition temperature (Tg) of the resin particles is within the above-described range, the clogging recovery property may be excellent. The glass transition temperature (Tg) of the resin particles can be confirmed by a method using differential scanning calorimetry (DSC) or the like.

A content of the resin particles (solid content) is preferably 3% by mass or more, more preferably 5% by mass or more, still more preferably 8% by mass or more, and particularly preferably 10% by mass or more, with respect to the total amount of the white ink composition. In addition, the content of the resin particles (solid content) is preferably 30% by mass or less, more preferably 20% by mass or less, and still more preferably 15% by mass or less, with respect to the total amount of the white ink composition.

### Wax

The white ink composition may contain a wax. Examples of the wax include, although not particularly limited, a hydrocarbon wax and an ester wax which is a condensate of fatty acid and monohydric alcohol or polyhydric alcohol. Although not particularly limited, examples of the hydrocarbon wax include a paraffin wax and polyolefin waxes such as polyethylene wax and polypropylene wax. These waxes may be used alone or in combination of two or more thereof.

Examples of commercially available paraffin wax include, AQUACER497 and AQUACER539 (product names, manufactured by BYK).

Examples of commercially available polyolefin wax include, Chemipearl S120, S650, and S75N (product names, manufactured by Mitsui Chemicals, Inc.), AQUACER501, AQUACER506, AQUACER513, AQUACER515, AQUACER526, AQUACER593, and AQUACER582 (product names, manufactured by BYK).

A content of the wax (solid content) is preferably 0.1% by mass or more, more preferably 0.5% by mass or more, still more preferably 1.0% by mass or more, and particularly preferably 1.5% by mass or more, with respect to the total amount of the white ink composition. In addition, the content of the wax (solid content) is preferably 10% by mass or less, more preferably 5% by mass or less, and still more preferably 3% by mass or less, with respect to the total amount of the white ink composition.

### Metal Sealing Agent

The white ink composition may contain a metal sealing agent (chelating agent). The metal sealing agent can remove predetermined ions in a reaction solution.

Examples of the metal sealing agent include ethylenediamine tetraacetic acid such as ethylenediamine tetraacetic acid (EDTA), ethylenediamine tetraacetic acid dihydrogen disodium salt (EDTA-2Na), ethylenediamine tetraacetic acid monohydrogen trisodium salt (EDTA-3Na), ethylenediamine tetraacetic acid tetrasodium salt (EDTA- 4Na), and ethylenediamine tetraacetic acid monohydrogen tripotassium salt (EDTA-3K) and salts thereof; diethylenetriamine pentaacetic acid such as DTPA, diethylenetriamine pentaacetic acid disodium salt (DTPA-2Na), and diethylenetriamine pentaacetic acid pentasodium salt (DTPA-5Na) and salts thereof; nitrilotriacetic acid such as NTA, nitrilotriacetic acid disodium salt (NTA-2Na), and nitrilotriacetic acid trisodium salt (NTA-3Na) and salts thereof; ethylenediamine-N, N′-disuccinic acid and salts thereof; 3-hydroxy-2,2′-iminodisuccinic acid and salts thereof; L-aspartic acid-N,N′-diacetic acid and salts thereof; and N-(2-hydroxyethyl) imminodiacetic acid and salts thereof. In addition, examples of the metal sealing agent include ethylenediaminetetramethylenephosphonic acid and salts thereof; ethylenediaminetetramethaphosphoric acid and salts thereof; ethylenediaminepyrophosphoric acid and salts thereof; and ethylenediaminemethaphosphoric acid and salts thereof.

The metal sealing agent may be used alone or in combination of two or more.

When the metal sealing agent is contained, a content thereof can be, for example, 0.005% by mass or more and 0.1% by mass or less, and preferably 0.01% by mass or more and 0.05% by mass or less, with respect to the total amount of the white ink composition.

### Other Components

The white ink composition may contain additives such as a pH adjusting agent, a preservative/antifungal agent, an antirust agent, a viscosity modifier, a solubilizing agent, an antioxidant, and an alkali agent, as necessary. When such an additive is contained, a content of the additive is preferably 0.1% to 5% by mass, more preferably 0.1% to 3% by mass, and still more preferably 0.1% to 1% by mass, with respect to the total amount of the white ink composition.

### 1.1.1. (6) Physical Properties

A viscosity of the white ink composition is preferably 1.0 to 10 mPas, more preferably 2.0 to 10 mPas, still more preferably 3.0 to 8.0 mPas, and particularly preferably 4.0 to 6.0 mPas at 20° C. In particular, when the viscosity is 4.0 mPa's or more, there is a tendency that more favorable color development properties are obtained. When the viscosity is 6.0 mPa's or less, there is a tendency that more favorable ejection stability is obtained.

A surface tension of the white ink composition is preferably 10 to 40 mN/m, more preferably 15 to 35 mN/m, still more preferably 20 to 30 mN/m, and particularly preferably 20 to 27 mN/m at 20° C.

### 1.1.2. Ink Jet Method

The white ink adhesion step is performed by main scanning in which a relative position between the ink jet head and the recording medium is moved.

The “ink jet method” is a method in which droplets of an ink jet ink are ejected from a nozzle of an ink jet head and adhered to a recording medium.

An adhesion amount of the white ink composition is preferably 4 to 30 mg/inch², more preferably 6 to 25 mg/inch², still more preferably 8 to 20 mg/inch², and particularly preferably 10 to 15 mg/inch² per unit area of a region where the white ink composition is adhered on the recording medium. In addition, among the adhesion amount of the white ink composition, a maximum adhesion amount may be in the above-described range, which is preferable.

In addition, a recording region where an adhesion amount of the white ink composition is 15 mg/inch² or more may be formed at the recording medium. In this case, the background hiding properties of the image formed by the white ink composition are further improved, and thus the effect of the present recording method of suppressing the unevenness of the image formed by the non-white ink composition is more remarkable.

In the recording method according to the present embodiment, after the white ink adhesion step, the non-white ink adhesion step described later is performed through the drying step described later, and the white ink composition and the non-white ink composition are adhered to each other on the recording medium. That is, a white image formed by the white ink composition is formed at the recording medium first, and after the drying step, a color image formed by the non-white ink composition is formed by being overlaid on the white image on the recording medium. In this case, unevenness of the color image is likely to occur, and thus the recording method according to the present embodiment is more effective.

A preferred adhesion aspect is that the white ink adhesion step and the non-white ink adhesion step described later are performed by scanning (hereinafter, also referred to as “scanning”) in which the ink is ejected from the ink jet head and adhered to the recording medium when the ink jet head and the recording medium are being moved to a relative position.

In the scanning, the ink jet head may move with respect to the recording medium, or the recording medium may move with respect to the ink jet head. That is, the movement of the ink jet head to a relative position with respect to the recording medium can be referred to as a movement of the recording medium to a relative position with respect to the ink jet head. That is, the relative position of the ink jet head and the recording medium is moved.

The ink jet head can be mounted on, for example, a carriage. The ink jet head may move by moving the carriage, and, that is, even this case is a movement of the ink jet head.

The number of times of the scanning performed on the same scanning region on the recording medium is not particularly limited, and may be one or a plurality of times independently in each of the white ink adhesion step and the non-white ink adhesion step.

When the number of times of the scanning performed on the same scanning region on the recording medium is set to a plurality of times, the ink jet head that ejects the ink passes through the same region on the recording medium a plurality of times. As the number of times of scanning increases, the ink can be adhered on a desired region a plurality of times (in a plurality of times of pass), and there is a tendency that the image quality of the obtained recorded matter is further improved. In this case, the number of times of scanning is 1 or more, preferably 2 or more, more preferably 3 or more, still more preferably 4 or more, and particularly preferably 6 or more from the viewpoint of the image quality being more excellent. The upper limit thereof is not limited, but from the viewpoint of productivity, it is preferably 15 or less, more preferably 10 or less, and still more preferably 8 or less. The number of times of the above-described scanning is provided for each type of ink.

In such a case of the plurality of passes, it is preferable to perform recording by performing the scanning (main scanning) and the sub-scanning a plurality of times, respectively. For example, the main scanning and the sub-scanning may be alternately repeated.

For example, when recording is performed in four passes, when the length of one sub-scan in the sub-scanning direction is one fourth of the length of the nozzle row in the sub-scanning direction of the ink jet head, which is in the sub-scanning direction, four main scans are performed on the same portion (same scanning region) for a rectangular scanning region extending in the main scanning direction and having the length of one sub-scan in the sub-scanning direction. The number of times of scanning when viewed in this way is referred to as the number of scanning, the number of passes, or the like.

The “sub-scanning” refers to an operation of moving the relative position of the ink jet head and the recording medium in the sub-scanning direction. The “sub-scanning direction” is a direction intersecting the main scanning direction (that is, a direction in which the relative position of the ink jet head with respect to the recording medium is moved).

For example, the ink is adhered to a region of the recording medium in the main scanning, the recording medium is slightly moved in the sub-scanning, for example, and the next main scanning is further performed. By repeating the operation of adhering the ink adjacent to or partially overlapping the ink adhered first, recording can be performed. Also, the “sub-scanning” is a movement of the ink jet head to the relative position with respect to the recording medium. The ink jet head may move to the recording medium, and the recording medium may move to the ink jet head. A direction of such a relative movement is a sub-scanning direction.

On the other hand, it is also preferable that the number of times of the scanning performed on the same scanning region in the recording medium be set to one time in the white ink adhesion step and one time in the non-white ink adhesion step. In this case, the white ink composition is likely to be insufficiently embedded on the recording medium, and unevenness of the color image is also likely to occur. However, with the recording method according to the present embodiment, even in such an aspect, the embedment of the white ink on the recording medium can be made favorable and the occurrence of unevenness of the color image can be reduced.

When the number of times of the scanning performed on the same scanning region on the recording medium is set to one time in the white ink adhesion step and one time in the non-white ink adhesion step, the scanning may be performed by the same scanning or may be performed by different scanning.

Furthermore, a direction of first main scanning in the non-white ink adhesion step described later may be a direction opposite to a direction of last main scanning in the white ink adhesion step on the same main scanning region of the recording medium. That is, after the white ink composition is applied onto the recording medium by the main scanning, the non-white ink composition may be adhered by the next return main scanning without performing sub-scanning. Even in this case, the drying step can be performed by, for example, a platen heater or blowing air.

In the present specification, when the non-white ink composition is adhered by the next main scanning after the white ink composition is applied onto the recording medium by the main scanning without performing the sub-scanning, a case in which the “next main scanning” is scanning in the same direction as the “main scanning” may be referred to as “Uni-d”; and a case in which the “next main scanning” is scanning in the opposite direction to the “main scanning” may be referred to as “Bi-d”.

### 1.1.3. Recording Medium

In the recording method according to the present embodiment, a low-absorptive recording medium or a non-absorptive recording medium is used as the recording medium.

The term low-absorptive recording medium or non-absorptive recording medium refers to a recording medium having a property of not absorbing liquid at all or absorbing little liquid. Quantitatively, the low-absorptive recording medium or non-absorptive recording medium refers to “recording medium in which a water absorption amount from the start of contact to 30 msec^{1/2} in the Bristow method is 10 mL/m² or less”. The Bristow method is the most popular method as a method of measuring a liquid absorption amount in a short time, and is also adopted by the Japan Technical Association of the Pulp and Paper Industry (JAPAN TAPPI). Details of a test method are described in “Paper and Paperboard-Liquid-Absorptivity Test Method-Bristow Method” of Standard No. 51 of “JAPAN TAPPI Paper and Pulp Test Method 2000 Edition”. On the other hand, the absorptive recording medium refers to a recording medium that does not correspond to a low-absorptive recording medium or a non-absorptive recording medium.

Examples of the low-absorptive recording medium include a recording medium having a low-absorptive coating layer provided on a surface thereof, and the low-absorptive recording medium is referred to as a coated paper. Examples of the recording medium whose base material is paper include printed paper such as art paper, coated paper, and matte paper. When the base material is a plastic film, examples thereof include recording media in which a polymer or the like is coated onto a surface such as polyvinyl chloride, polyethylene terephthalate, polycarbonate, polystyrene, polyurethane, polyethylene, and polypropylene, and recording media in which particles such as silica, titanium, and the like are coated with a binder.

Examples of the non-absorptive recording medium include a medium in which plastic is coated on a base material such as paper, a medium in which a plastic film adheres to the base material such as paper, and a plastic film without an absorbing layer (receiving layer). Examples of the plastic include polyvinyl chloride, polyethylene terephthalate, polycarbonate, polystyrene, polyurethane, polyethylene, polypropylene, and the like.

### 1.2. Drying Step

The recording method according to the present embodiment includes a drying step of drying the white ink composition adhered to the recording medium. After the white ink adhesion step, the non-white ink composition is adhered to the white ink composition by the non-white ink adhesion step described later to overlap the white ink composition dried by the drying step.

When the drying of the white ink composition progresses by the drying step, the abrasion resistance and the like of the obtained recorded matter can be further improved, but the filling of the white ink composition on the recording medium is likely to be insufficient, and thus the unevenness of the color image is also likely to occur. However, with the recording method according to the present embodiment, the image quality of the white ink composition can be improved, and the occurrence of the unevenness of the color image can be reduced.

The drying step is a step of heating the recording medium before the white ink adhesion step, or performing heating or blowing on the recording medium during the white ink adhesion step or in the early stage after the white ink composition is adhered to the recording medium to dry the ink at an early stage.

The drying step is a step for drying at least a part of a solvent component in the ink to an extent that the ink adhered to the recording medium is at least reduced in the flow of the ink. The drying step may be performed so that the ink is adhered to the heated recording medium, or may be performed at an early stage after the adhesion to promote drying.

In the drying step, it is preferable that the ink droplet that has landed on the recording medium starts to dry within 0.5 seconds at the latest from the landing of the ink droplet. The drying unit (drying mechanism) for drying the ink on the recording medium is not particularly limited, but examples thereof include a platen heater, a hot air heater, an IR heater, and the like having a heating function, and a blower or the like having no heating function.

Examples of the type of the drying mechanism include a conductive type that conducts heat from a member in contact with the recording medium to the recording medium to heat the recording medium, a radiation type that radiates radiation such as IR to the recording medium to heat the recording medium, and a blowing type that blows air toward the recording medium. Two or more types of the drying mechanisms may be used in combination. In particular, the blowing type and the other types may be used in combination.

Examples of the blowing type include a method of heating the recording medium when blowing air with warm air, and a method of promoting drying of the ink with air at room temperature without heating. In a method that does not include heating, it is preferable that the ink in the nozzles of the ink jet head can be suppressed from drying to decrease ejection stability. It is also preferable to use any one of the conductive type and the radiation type, and the blowing type in combination. When used in combination, a method that does not include heating may be used, which is preferable. When the drying step is performed by blowing air without heating, the effect of suppressing the unevenness of the image formed by the non-white ink composition is more remarkable.

In the drying step, the surface temperature of the recording medium is preferably 60° C. or lower, and more preferably 55° C. or lower. Furthermore, the surface temperature is more preferably 30° C. to 50° C., and still more preferably 30° C. to 45° C. On the other hand, the surface temperature is more preferably 40° C. or lower, still more preferably 35° C. or lower, particularly preferably 30° C. or lower, and still more preferably 25° C. to 28° C.

When the surface temperature of the recording medium is within the above-described range, there is a tendency that the drying property is further improved, and the abrasion resistance of the obtained recorded matter is further improved. In addition, it is preferable that the clogging recovery property, the ejection stability, or the color development properties are more excellent.

When the blowing type is used, the wind speed in the vicinity of the recording medium is preferably 0.5 to 10 m/s, more preferably 1 to 5 m/s, and still more preferably 2 to 3 m/s. The wind temperature is preferably 45° C. or lower, more preferably 40° C. or lower, still more preferably 32° C. or lower, and particularly preferably 20° C. to 27° C. In this manner, the unevenness of the image formed by the non-white ink composition can be further suppressed.

The drying step may include a blowing step of blowing air to the white ink composition adhered to the recording medium.

As described above, in the drying step, the degree of drying of the white ink composition when overlapping and adhering the non-white ink composition varies depending on the position of the recording medium, and a state in which the drying of the white ink composition has not progressed or a state in which the drying of the white ink composition has progressed occurs; but when using the white ink according to the present embodiment, the image quality unevenness of the non-white ink can be reduced even when performing the drying step.

### 1.3. Non-White Ink Adhesion Step

The non-white ink adhesion step is performed by main scanning in which a relative position between the ink jet head and the recording medium is moved after the main scanning of the white ink adhesion step. In the non-white ink adhesion step, the non-white ink composition is adhered to the white ink composition dried by the drying step in an overlaid manner.

### 1.3.1. Non-White Ink Composition

The non-white ink composition may have the same formulation as the formulation of the white ink composition, except that the non-white ink composition contains a non-white color material instead of the white color material and does not contain the above-described silicone-based surfactant A.

The non-white ink composition is an ink having a color other than white, and the color is not limited but may be, for example, black ink, yellow ink, magenta ink, cyan ink, orange ink, green ink, or the like.

Hereinafter, each component contained in the non-white ink composition will be described. Hereinafter, the components common to the above-described white ink composition can have the same composition as the white ink composition, unless otherwise specified.

### 1.3.1. (1) Non-White Color Material

The non-white ink composition contains a non-white color material. The non-white color material is a color material other than the white color material, and examples thereof include non-white pigments and dyes. As the pigment, for example, an inorganic pigment or an organic pigment can be used.

The inorganic pigment is not particularly limited, and examples thereof include carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite).

Examples of commercially available product of carbon black include No. 2300, 900, MCF88, No. 20B, No. 33, No. 40, No. 45, No. 52, MA7, MA8, MA100, No. 2200B, and the like manufactured by Mitsubishi Chemical Corporation; Color Black FW1, FW2, FW2V, FW18, FW200, S150, S160, S170, Pretex 35, U, V, 140U, Special Black 6, 5, 4A, 4, 250, and the like manufactured by Degussa Corporation; Conductex SC, Raven 1255, 5750, 5250, 5000, 3500, 1255, 700, and the like manufactured by Columbia Carbon Company; Regal 400R, 330R, 660R, Mogul L, Monarch 700, 800, 880, 900, 1000, 1100, 1300, 1400, Elftex 12, and the like manufactured by Cabot Corporation; and the like.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzoimidazolone-based pigment, an isoindolinone-based pigment, an azomethine-based pigment, an azo-based pigment, and the like.

Specific examples of the organic pigment include the following ones.

Examples of the cyan pigment include C.I. Pigment Blue 1, 2, 3, 15:3, 15:4, 15:34, 16, 22, 60, and the like; C.I. Vat Blue 4, 60; and the like, and are preferably a mixture of one or two or more selected from the group consisting of C.I. Pigment Blue 15:3, 15:4, and 60.

Examples of the magenta pigment include C.I. Pigment Red 5, 7, 12, 48 (Ca), 48 (Mn), 57 (Ca), 57:1, 112, 122, 123, 168, 184, 202, C.I. Pigment Violet 19, and the like, and are preferably a mixture of one or two or more selected from the group consisting of C.I. Pigment Red 122, 202, and 209, and C.I. Pigment Violet 19.

Examples of the yellow pigment include C. I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferably include a mixture of one or two or more selected from the group consisting of C. I. Pigment Yellow 74, 109, 110, 128, 138, 150, and 180.

Pigments of other colors can also be used. Examples thereof include an orange pigment, a green pigment, and the like.

The pigment may be used alone or in combination of two or more.

Even in the pigment as a non-white color material, it is the same as the white color material that it is preferable to perform a surface treatment on the color material or to blend a dispersant or the like in order to enhance the dispersibility in the ink composition, and the same description as mentioned above can be made.

Although not particularly limited, acid dye, direct dye, reactive dye, and basic dye can be used as the dye. The dye may be used alone or in combination of two or more.

The dye is not particularly limited, but examples thereof include C. I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

A content of the non-white color material is preferably 0.1% by mass or more and 10% by mass or less, more preferably 18 by mass or more and 8% by mass or less, and still more preferably 2% by mass or more and 6% by mass or less, with respect to the total amount of the non-white ink composition.

### 1.3.1. (2) Water

The non-white ink composition is an aqueous ink jet ink. The “aqueous” composition can be the same as that of the above-described white ink composition.

A content of water is preferably 508 by mass or more, and more preferably 50% to 100% by mass in a liquid medium component. Further, the content is preferably 60% to 90% by mass, and more preferably 75% to 85% by mass. Here, the liquid medium is a solvent component such as water and an organic solvent.

In addition, the content of water is preferably 30% by mass or more, more preferably 408 by mass or more, and still more preferably 50% by mass or more, with respect to the total mass of the non-white ink composition. An upper limit of the water content is not particularly limited, but is, for example, preferably 99% by mass or less, more preferably 90% by mass or less, and 80% by mass or less, with respect to the total mass of the non-white ink composition.

### 1.3.1. (3) Surfactant

The non-white ink composition may contain the above-described silicone-based surfactant A or other silicone-based surfactants other than the silicone-based surfactant A (hereinafter, also referred to as “other silicone-based surfactants”).

A weight average molecular weight Mw of the other silicone-based surfactant is not particularly limited, but is preferably 8,000 or less, more preferably 7,000 or less, and still more preferably 5,000 or less. In addition, a lower limit of the weight average molecular weight Mw is not particularly limited, but is preferably more than 2,000, more preferably more than 3,000, and still more preferably more than 4,000.

It is also preferable to measure the weight average molecular weight Mw of the other silicone-based surfactant by gel permeation chromatography (GPC) as described above.

The surface tension of an aqueous solution with 0.1% by mass of the other silicone-based surfactant is preferably 35 mN/m or less, more preferably 33 mN/m or less, still more preferably 30 mN/m or less, and particularly preferably 28 mN/m or less. The lower limit of the surface tension is not particularly limited, but is preferably 15 mN/m or more, more preferably 17 mN/m or more, and even more preferably 20 mN/m or more.

Examples of the other silicone-based surfactant include SAG002 (Silface SAG002 (manufactured by Nissin Chemical co., ltd.), not satisfying the condition (a)), SAG503A (Silface SAG503A (manufactured by Nissin Chemical co., ltd.), not satisfying the condition (a)), SAG005 (Silface SAG005 (manufactured by Nissin Chemical co., ltd.), not satisfying the condition (a)), BYK-333 (silicone-based surfactant (manufactured by BYK Japan KK.), not satisfying the condition (a)), BYK-348 (silicone-based surfactant (manufactured by BYK Japan KK.), not satisfying the condition (a)), and BYK-349 (silicone-based surfactant (manufactured by BYK Japan KK.), not satisfying the condition (a)).

In addition, the non-white ink composition may contain a surfactant other than the silicone-based surfactant. The surfactant has a function of adjusting the surface tension of the non-white ink composition, for example, adjusting the wettability with the white ink composition on the recording medium. Among the surfactants, for example, an acetylene glycol-based surfactant or a fluorine-based surfactant can be preferably used.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all product names, manufactured by Air Products & Chemicals. Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all product names, manufactured by Nissin Chemical co., ltd.), and ACETYLENOL E00, EOOP, E40, and E100 (all product names, manufactured by Kawaken Fine Chemicals Co., Ltd.).

As the fluorine-based surfactant, a fluorine-modified polymer is preferably used, and specific examples thereof include BYK-3440 (manufactured by BYK Japan KK.), SURFLON S-241, S-242, and S-243 (all product names, manufactured by AGC SEIMI CHEMICAL CO., LTD.), and FTERGENT 215M (manufactured by NEOS COMPANY LIMITED).

A content of the surfactant in the non-white ink composition can be the same as the content of the specific polyether-modified silicone-based surfactant in the white ink composition.

### 1.3.1. (4) Other Components

### Organic Solvent

The non-white ink composition may contain an organic solvent. When the ink composition contains the organic solvent, there is a tendency that the wet spreadability of the ink can be made more favorable, and there is a tendency that the occurrence of unevenness of a color image can be further reduced.

The configuration of the organic solvent in the non-white ink composition can be the same as that of the above-described white ink composition.

### Resin Particles

The non-white ink composition may contain resin particles. The composition of the resin particles in the non-white ink composition can be the same as that of the above-described white ink composition.

A content of the resin particles (solid content) is preferably 0.1% by mass or more, more preferably 0.5% by mass or more, still more preferably 18 by mass or more, and particularly preferably 2% by mass or more, with respect to the total amount of the non-white ink composition. In addition, the content of the resin particles (solid content) is preferably 15% by mass or less, more preferably 10% by mass or less, and still more preferably 8% by mass or less, with respect to the total amount of the non-white ink composition.

### Wax

The non-white ink composition may contain a wax. The composition of the wax in the non-white ink composition can be the same as that of the above-described white ink composition.

### Metal Sealing Agent

The non-white ink composition may contain a metal sealing agent. The composition of the metal sealing agent in the non-white ink composition can be the same as that of the above-described white ink composition.

### Other Components

The non-white ink composition may contain additives such as a pH adjusting agent, a preservative/antifungal agent, an antirust agent, a viscosity modifier, a solubilizing agent, and an antioxidant, as necessary. When such an additive is contained, a content of the additive is preferably 0.1% to 5% by mass, more preferably 0.1% to 3% by mass, and still more preferably 0.1% to 18 by mass with respect to the total amount of the non-white ink composition.

### 1.3.1. (5) Physical Properties

The viscosity and surface tension in the non-white ink composition can be the same as that of the above-described white ink composition.

### 1.3.2. Ink Jet Method and Recording Medium

The non-white ink adhesion step is performed by main scanning in which a relative position between the ink jet head and the recording medium is moved.

The ink jet method is the same as the white ink adhesion step described above, and is performed by main scanning in which a relative position between the ink jet head and the recording medium is moved after the main scanning of the white ink adhesion step. In addition, the recording medium is the same as the white ink adhesion step described above.

### 1.4. Treatment Liquid Adhesion Step

The recording method according to the present embodiment may include a treatment liquid adhesion step. In the treatment liquid adhesion step, a treatment liquid containing an aggregating agent is adhered to the recording medium.

### 1.4.1. Treatment Liquid

The treatment liquid is preferably an aqueous treatment liquid containing an aggregating agent. In addition, the treatment liquid may contain the above-described silicone-based surfactant A, and it is more preferable that the treatment liquid contains the silicone-based surfactant A.

### 1.4.1. (1) Aggregating Agent

The treatment liquid contains an aggregating agent that aggregates components of the ink composition. The aggregating agent has an effect of aggregating the color material and the resin particles by reacting with the components such as the color material contained in the ink, the resin particles contained in the ink, and the like. However, the degree of aggregation of the color material and the resin particles by the aggregating agent varies depending on each type of the aggregating agent, the color material, and the resin particles, and can be adjusted. In addition, the aggregating agent can aggregate the color material and the resin particles by reacting with the color material and the resin particles contained in the ink. With such aggregation, it is possible to enhance the color development of the color material, to enhance the fixability of the resin particles, and/or to increase the viscosity of the ink.

Although the aggregating agent is not particularly limited, examples thereof include a metal salt, an inorganic acid, an organic acid, and a cationic compound, and as the cationic compound, a cationic resin (cationic polymer), a cationic surfactant, and the like can be used. Among these, a polyvalent metal salt is preferable as the metal salt, and a cationic resin is preferable as the cationic compound. Therefore, as the aggregating agent, it is preferable to select any one of a cationic resin, an organic acid, and a polyvalent metal salt from the viewpoint of obtaining particularly excellent image quality, abrasion resistance, gloss, and the like.

The metal salt is preferably a polyvalent metal salt, but metal salts other than polyvalent metal salts can be used. Among these aggregating agents, it is preferable to use at least one selected from a metal salt and an organic acid from the viewpoint of excellent reactivity with components included in the ink. In addition, among the cationic compounds, a cationic resin is preferably used from the viewpoint of easy dissolution in the treatment liquid. In addition, a plurality of types of aggregating agents can be used in combination.

The polyvalent metal salt is a compound configured with a di- or higher valent metal ion and an anion. Examples of the di- or higher valent metal ion include ions of calcium, magnesium, copper, nickel, zinc, barium, aluminum, titanium, strontium, chromium, cobalt, iron, and the like. Among the metal ions constituting these polyvalent metal salts, at least one of the calcium ion and the magnesium ion is preferable from the viewpoint that the aggregability of the components of the ink is excellent.

The anion constituting the polyvalent metal salt is an inorganic ion or an organic ion. That is, the polyvalent metal salt in the present disclosure consists of an inorganic ion or an organic ion and a polyvalent metal. Examples of the inorganic ion include a chloride ion, a bromine ion, an iodine ion, a nitrate ion, a sulfate ion, and a hydroxide ion. Examples of the organic ion include an organic acid ion. Examples of the organic acid ion include a carboxylic acid ion.

A polyvalent metal compound is preferably an ionic polyvalent metal salt, and in particular, when the above-described polyvalent metal salt is a magnesium salt or a calcium salt, more favorable stability of the treatment liquid is achieved. In addition, any of an inorganic acid ion or an organic acid ion may be used as a counterion of the polyvalent metal.

Specific examples of the above-described polyvalent metal salt include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium formate, calcium acetate, magnesium acetate, and aluminum acetate. The polyvalent metal salt may be used alone or in combination of two or more. Among the above, at least any of calcium formate, magnesium sulfate, calcium nitrate, or calcium chloride is preferably used, and calcium formate or calcium nitrate is more preferably used because sufficient solubility in water can be secured, and traces of the treatment liquid are reduced (traces are not noticeable). These metal salts may have water of hydration in a raw material form.

Examples of a metal salt other than the polyvalent metal salt include a monovalent metal salt such as a sodium salt and a potassium salt, and examples of the monovalent metal salt include sodium sulfate and potassium sulfate.

Suitable examples of the organic acid include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyrone carboxylic acid, pyrrole carboxylic acid, furancarboxylic acid, pyridine carboxylic acid, coumaric acid, thiophene carboxylic acid, nicotinic acid, derivatives of compounds thereof, and salts thereof. The organic acid may be used alone or in combination of two or more. The above-described metal salt includes a metal salt that is a salt of the organic acid.

Examples of the inorganic acid include sulfuric acid, hydrochloric acid, nitric acid, and phosphoric acid. The inorganic acid may be used alone or in combination of two or more.

Examples of the cationic resin (cationic polymer) include a cationic urethane-based resin, a cationic olefin-based resin, a cationic amine-based resin, and the like. The cationic polymer is preferably water-soluble.

Commercially available products can be used as the cationic urethane-based resin, and for example, HYDRAN CP-7010, CP-7020, CP-7030, CP-7040, CP-7050, CP-7060, and CP-7610 (product names, manufactured by DIC Corporation), SUPERFLEX 600, 610, 620, 630, 640, and 650 (product name, manufactured by DKS Co., Ltd.), urethane emulsion WBR-2120C and WBR-2122C (product names, manufactured by Taisei Fine Chemical Co., Ltd.), or the like can be used.

The cationic olefin resin has an olefin such as ethylene and propylene in the structural skeleton, and known olefin resins can be appropriately selected and used. In addition, the cationic olefin resin may be in an emulsion state of being dispersed in a solvent containing water, an organic solvent, or the like. As the cationic olefin resin, a commercially available product can be used, and examples thereof include ARROWBASE CB-1200 and CD-1200 (product name, manufactured by Unitika Ltd.).

As the cationic amine-based resin (cationic polymer), any resin having an amino group in the structure may be used, and known ones can be appropriately selected and used. Examples thereof include polyamine resin, polyamide resin, polyallylamine resin, and the like. The polyamine resin is a resin having an amino group in the main skeleton of the resin. The polyamide resin is a resin having an amide group in the main skeleton of the resin. The polyallylamine resin is a resin having a structure derived from an allyl group in the main skeleton of the resin.

In addition, as the cationic polyamine-based resin, Unisense KHE103L (hexamethylenediamine/epichlorohydrin resin, 1% aqueous solution of a pH of substantially 5.0, viscosity: 20 to 50 (mPa·s), an aqueous solution with a solid component concentration of 50% by mass) manufactured by Senka Co., Ltd., Unisense KHE104L (dimethylamine/epichlorohydrin resin, 1% aqueous solution of a pH of substantially 7.0, viscosity: 1 to 10 (mPa·s), an aqueous solution with a solid component concentration of 20% by mass), or the like can be used. In addition, specific examples of commercially available products of the cationic polyamine-based resin include FL-14 (manufactured by SNF Co. Ltd.), ARAFIX 100, 251S, 255, and 255LOX (manufactured by Arakawa Chemical Industries, Ltd.), DK-6810, 6853, and 6885, and WS-4010, 4011, 4020, 4024, 4027, and 4030 (manufactured by Seiko PMC Corporation), Papiogen P-105 (manufactured by Senka), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Company, Limited), and Jetfix 36N, 38A, 5052 (manufactured by Satoda Kako Co., Ltd.).

Examples of the polyamine-based resin include a polyallylamine resin. Examples of the polyallylamine resin include polyallylamine hydrochloride, polyallylamineamide sulfate, allylamine hydrochloride/diallylamine hydrochloride copolymers, allylamine acetate/diallylamine acetate copolymers, allylamine acetate/diallylamine acetate copolymers, allylamine hydrochloride/dimethylallylamine hydrochloride copolymers, allylamine/dimethylallylamine copolymers, polydiallylamine hydrochloride, polymethyldiallylamine hydrochloride, polymethyldiallylamineamide sulfate, polymethyldiallylamine acetate, polydiallyldimethylammonium chloride, diallylamine acetate/sulfur dioxide copolymers, diallylmethylethylammonium ethylsulfate/sulfur dioxide copolymers, methyldiallylamine hydrochloride/sulfur dioxide copolymers, diallyldimethylammonium chloride/sulfur dioxide copolymers, and diallyldimethylammonium chloride/acrylamide copolymers.

A plurality of types of the aggregating agents may be used. When at least one type of the polyvalent metal salt, the organic acid, and the cationic resin is selected from the aggregating agents, more favorable agglomerating action is achieved, and thus an image having higher image quality (in particular, a favorable color developing property) can be formed.

The total content of the aggregating agent in the treatment liquid is, for example, 0.1% by mass or more and 20% by mass or less with respect to the total mass of the treatment liquid, preferably 18 by mass or more and 20% by mass or less, and more preferably 2% by mass or more and 15% by mass or less. Even when the aggregating agent is common to both the solution and the dispersion, the content of the solid content is preferably within the above-described range. When the content of the aggregating agent is 18 by mass or more, it is possible to obtain a sufficient performance in terms of the aggregating agent aggregating the components contained in the ink. In addition, by setting the content of the aggregating agent to be 30% by mass or less, the solubility and dispersibility of the aggregating agent in the treatment liquid are improved, and it is possible to improve storage stability and the like of the treatment liquid.

Even when the organic solvent contained in the treatment liquid has high hydrophobicity, from the viewpoint of favorable solubility of the aggregating agent in the treatment liquid, it is preferable to use an aggregating agent in which the solubility in 100 g of water at 25° C. is 1 g or more, and more preferable to use an aggregating agent in which the solubility is 3 g or more and 80 g or less. 1.4.1. (2) Water

The treatment liquid is an aqueous treatment liquid. The “aqueous” composition can be the same as that of the above-described white ink composition.

### 1.4.1. (3) Silicone-Based Surfactant A

The treatment liquid may contain a silicone-based surfactant A. Since the silicone-based surfactant A is the same as that described in the description of the white ink adhesion step, the description thereof will not be repeated.

### 1.4.1. (4) Other Components

The treatment liquid may contain a surfactant, an organic solvent, and other components. These components can be the same as those of the white ink composition described above.

### 1.4.1. (5) Physical Properties of Treatment Liquid

The surface tension of the treatment liquid at 25° C. is 40 mN/m or less, preferably 38 mN/m or less, more preferably 35 mN/m or less, and still more preferably 30 mN/m or less from the viewpoint of ensuring appropriate wet spreadability to the recording medium. The surface tension can be measured by confirming the surface tension when a platinum plate is wetted with the composition in an environment of 25° C. using an automatic surface tensiometer CBVP-Z (manufactured by Kyowa Interface Science, Co., Ltd.).

It is more preferable that the treatment liquid is adhered to the recording medium by an ink jet method. In such a case, the viscosity at 20° C. is preferably 1.5 mPa·s or more and 15 mPa·s or less, more preferably 1.5 mPa·s or more and 7 mPa·s or less, and even more preferably 1.5 mPa·s or more and 5.5 mPa·s or less. When the treatment liquid is adhered to the recording medium by an ink jet method, it is easy to efficiently form a predetermined treatment liquid adhering region in the recording medium.

### 1.5. Other Steps

### Post-Heating Step

The recording method according to the present embodiment may further include a post-heating step of heating the recording medium after the above-described non-white ink adhesion step. The post-heating step can be performed, for example, by using an appropriate heating unit. The post-heating step is performed by, for example, an after-heater (corresponding to a heating heater 5 in an example of the ink jet recording device described later). In addition, the heating unit is not limited to the heating unit included in the ink jet recording device, and other drying units may be used. As a result, the obtained image can be dried and more sufficiently fixed, and thus, for example, the recorded matter can be brought in a state of being usable at an early stage.

A temperature of the recording medium in this case is not particularly limited, and may be set in consideration of Tg of a resin component constituting the resin particles contained in the recorded matter and the like, for example. When considering the Tg of the resin component constituting the resin particles or wax, the temperature of the recording medium may be set to be higher than the Tg of the resin component constituting the resin particles by 5.0° C. or higher, preferably 10.0° C. or higher.

The surface temperature of the recording medium reached by heating in the post-heating step is 30.0° C. or higher and 120.0° C. or lower, preferably 40.0° C. or higher and 100.0° C. or lower, more preferably 50.0° C. or higher and 95° C. or lower, and still more preferably 70° C. or higher and 90° C. or lower. The surface temperature of the recording medium reached by heating in the post-heating step is particularly preferably 80° C. or higher. When the temperature of the recording medium is in the range, the resin particles or wax contained in the recorded matter can be filmed and flattened, and the obtained image can be dried and more sufficiently fixed.

### 1.6. Other Conditions and the Like

In the recording method according to the present embodiment, movement lengths of the main scanning in the white ink adhesion step and the non-white ink adhesion step may be 50 cm or more, or 1 m or more, respectively. In this case, the time (difference in landing time) from the adhesion of the white ink composition to the adhesion of the non-white ink composition is long, and a condition in which the unevenness of the image formed by the non-white ink composition is likely to occur is formed; but since the white ink composition contains the silicone-based surfactant A, the unevenness of the image formed by the non-white ink composition can be suppressed. The above-described movement length is more preferably 1 to 3 m and still more preferably 1.5 to 2 m.

In addition, in the recording method according to the present embodiment, when the direction of the first main scanning in the non-white ink adhesion step is a direction opposite to the direction of the last main scanning in the white ink adhesion step on the same main scanning region (Bi-d), the time (difference in landing time) from the adhesion of the white ink composition to the adhesion of the non-white ink composition is non-uniform (the difference in landing time is large), and a condition in which the unevenness of the image formed by the non-white ink composition is likely to occur is obtained. However, since the white ink composition contains the silicone-based surfactant A, the unevenness of the image formed by the non-white ink composition can be suppressed.

### 1.7. Action and Effect

In the recording method according to the present embodiment, since the white ink composition contains the silicone-based surfactant A, both the droplets of the non-white ink composition in contact with the white ink composition in a state in which the drying has not progressed after the landing of the white ink composition on the recording medium and the droplets of the non-white ink composition in contact with the white ink composition in a state in which the drying has progressed after the landing of the white ink composition on the recording medium have similar wettability of the droplets of the non-white ink composition, the difference in the image quality of the color image is small, and thus the image unevenness can be suppressed.

In the recording method according to the present embodiment, since the drying step (heating on the platen, blowing air, or the like) is included, the image quality (unevenness) of the white ink composition is likely to be suppressed; but the drying is promoted, and the color image unevenness is likely to occur. In addition, in the drying step, the drying unevenness is likely to occur, and the color image unevenness is likely to occur. However, in the recording method according to the present embodiment, the above-described effect can be sufficiently obtained.

The above-described effect can be sufficiently obtained even when the color image unevenness is likely to occur and the main scanning distance is long or even when the Bi-d printing. With a line printer, the time difference from the adhesion of the white ink composition to the adhesion of the non-white ink composition is short, the degree of drying of the white ink composition is not uneven, and the color image unevenness is unlikely to occur. From the viewpoint, the recording method according to the present embodiment is particularly useful for a serial-type ink jet recording device or a so-called lateral-type ink jet recording device.

### 2. Recording Device

An example of a recording device suitable for the recording method according to the present embodiment will be described with reference to the drawings. The recording device according to the present embodiment is configured to perform the above-described recording method, the recording device including: the white ink composition; the non-white ink composition; the ink jet head configured to perform the white ink adhesion step; a drying mechanism configured to perform the drying step; and the ink jet head configured to perform the non-white ink adhesion step.

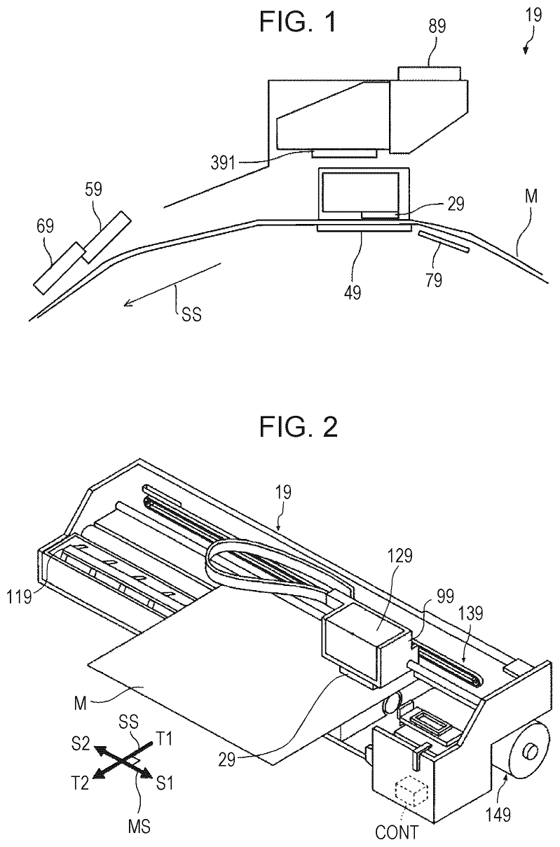

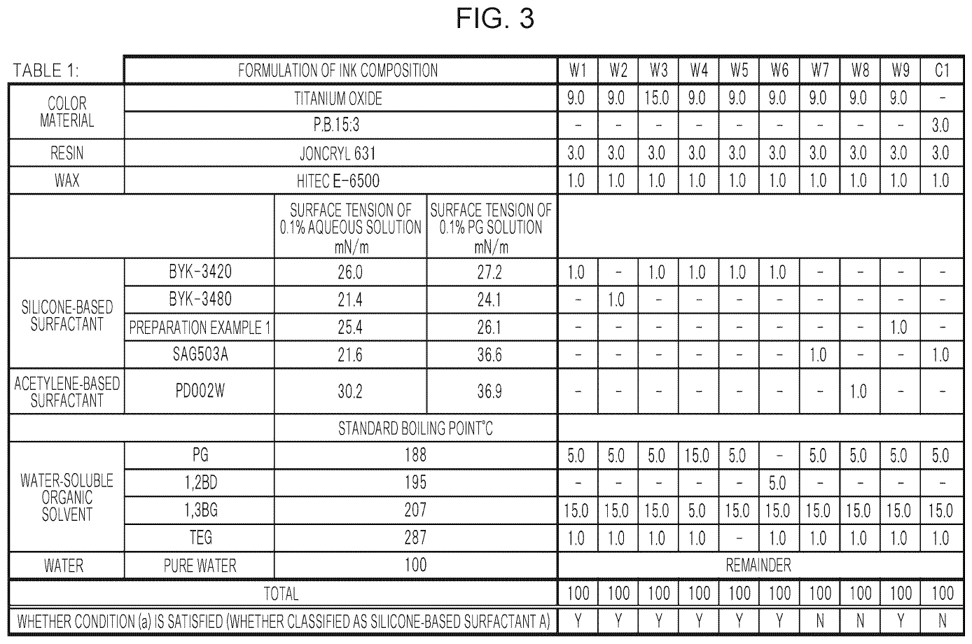

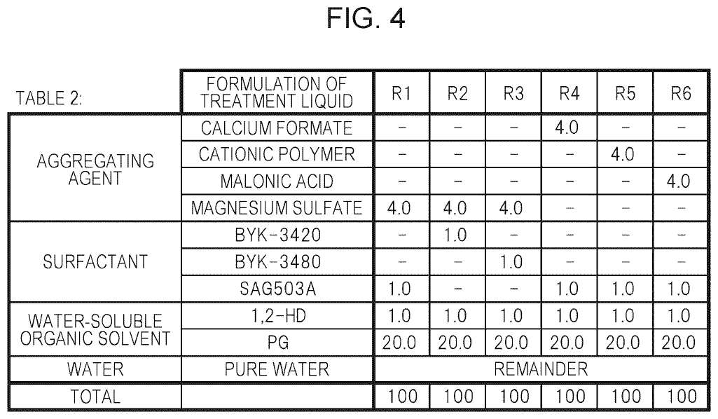

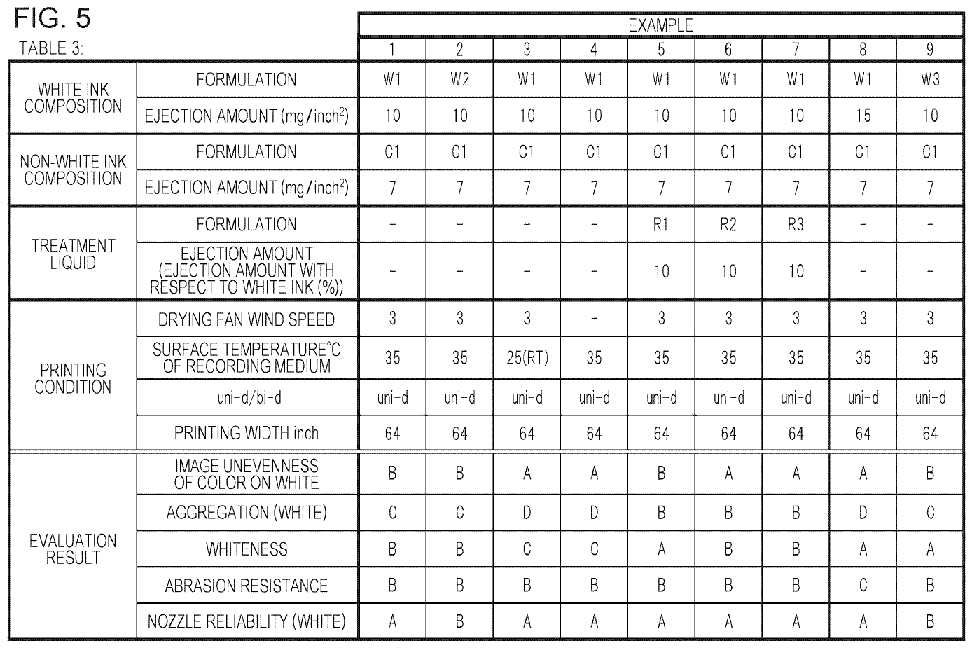

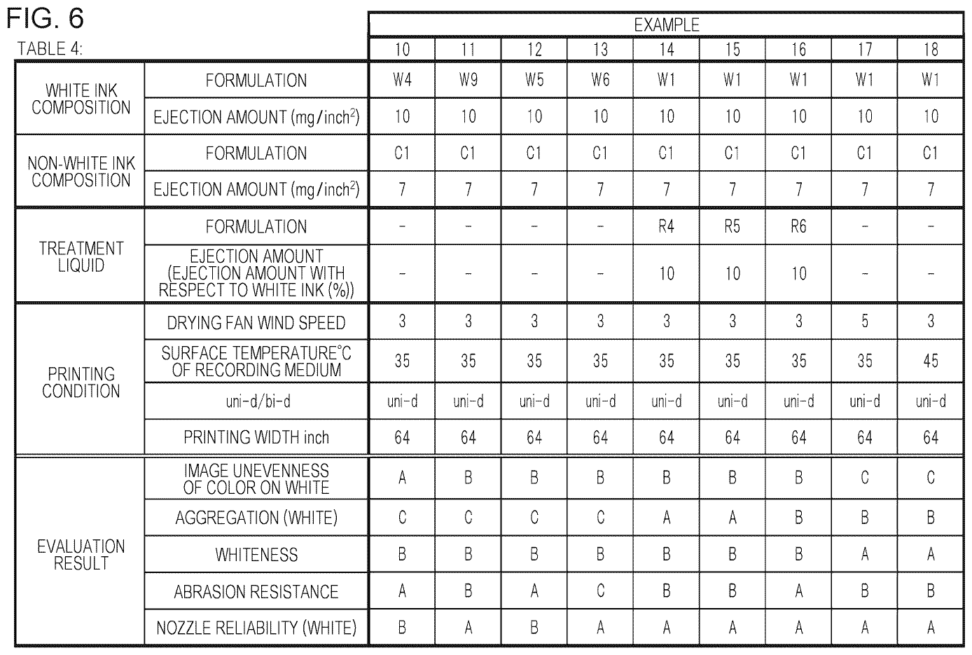

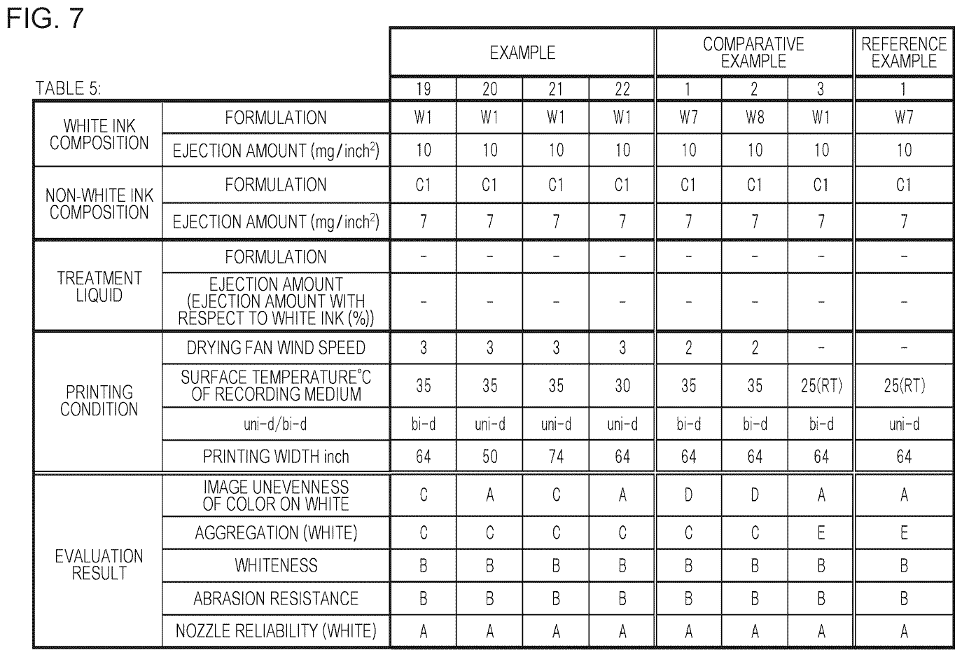

FIG. 1 is a schematic cross-sectional view schematically showing an ink jet recording device 1. FIG. 2 is a perspective view showing an example of a configuration around a carriage of the ink jet recording device 1 of FIG. 1.

As shown in FIGS. 1 and 2, the ink jet recording device 1 includes an ink jet head 2, an IR heater 3, a platen heater 4, a heating heater 5, a cooling fan 6, a preheater 7, a ventilation fan 8, a carriage 9, a platen 11, a carriage moving mechanism 13, a transport unit 14, and a controller CONT. In the ink jet recording device 1, the operation of the entire ink jet recording device 1 is controlled by the controller CONT shown in FIG. 2.

The ink jet head 2 has an ink jet head that ejects a white ink composition and an ink jet head that ejects a non-white ink composition, and can perform recording on a recording medium M by ejecting the white ink composition and the non-white ink composition from nozzles of each of the ink jet heads and adhering the white ink composition and the non-white ink composition.

In the present embodiment, the ink jet head 2 is a serial type ink jet head, and scans the recording medium M one or a plurality of times in a main scanning direction relative to the recording medium M to adhere the white ink composition and the non-white ink composition to the recording medium M. The ink jet head 2 is mounted on the carriage 9 shown in FIG. 2. The ink jet head 2 is scanned one or a plurality of times in the main scanning direction relative to the recording medium M by an operation of the carriage moving mechanism 13 that moves the carriage 9 in a medium width direction of the recording medium M. The medium width direction is the main scanning direction of the ink jet head 2. Scanning in the main scanning direction is also referred to as main scanning.

In addition, here, the main scanning direction is a direction in which the carriage 9 on which the ink jet head 2 is mounted moves. In FIG. 1, the main scanning direction is a direction intersecting a sub-scanning direction, which is a transport direction of the recording medium M indicated by the arrow SS. In FIG. 2, a width direction of the recording medium M, that is, a direction represented by S1↔S2 is a main scanning direction MS, and a direction represented by T1→T2 is a sub-scanning direction SS. In addition, scanning is performed in the main scanning direction, that is, in a direction of either the arrow S1 or the arrow S2 in one scan.

A cartridge 12 that supplies each ink to the ink jet head 2 includes a plurality of independent cartridges. The cartridge 12 is detachably mounted on the carriage 9 in which the ink jet head 2 is mounted. Each of the plurality of the cartridges is filled with different types of inks, and the ink is supplied to each nozzle from the cartridges 12. The above-described recording method can be performed by filling at least one of the cartridges 12 with the white ink composition and filling at least one of the other cartridges 12 with the non-white ink composition.

In the present embodiment, an example in which the cartridge 12 is mounted on the carriage 9 is shown, but the cartridge 12 is not limited thereto, and may be in the form of being provided on a site other than the carriage 9 and supplied to each nozzle through a supply pipe not shown in the figure.

A method known in the related art can be used for ejecting of the ink jet head 2. In the present embodiment, a method of ejecting droplets by using vibration of a piezoelectric element, that is, an ejection method of forming ink droplets by mechanical deformation of an electrostrictive element is used.

The ink jet recording device 1 includes the ventilation fan 8, the IR heater 3, and the platen heater 4 for drying the ink ejected from the ink jet head 2 and adhered to the recording medium M. The drying step can be performed by appropriately using these ventilation fan 8, the IR heater 3, and the platen heater 4 in combination. In the drying step, it is not always necessary to heat the recording medium M, and the ventilation fan 8 may be used alone for carrying out the normal temperature air blowing.

When the IR heater 3 is used, the recording medium M can be radiatively heated by infrared radiation from the ink jet head 2 side. Due to this, the ink jet head 2 is also likely to be heated at the same time, but the temperature can be raised without being affected by a thickness of the recording medium M as compared with the case of being heated from a back surface of the recording medium M such as the platen heater 4. In addition, there may be provided various fans (for example, ventilation fan 8), which blow warm air or air having the same temperature as the environment to the recording medium M to dry the ink on the recording medium M.

The platen heater 4 can heat the recording medium M at a position facing the ink jet head 2 through the platen 11 so that the ink ejected by the ink jet head 2 can be dried early from a time when being adhered to the recording medium M. The platen heater 4 can heat the recording medium the M in a conductive manner, and the ink or the like can be adhered to the recording medium M heated in this manner.

The surface temperature of the recording medium M due to the heating of the IR heater 3 and the platen heater 4 is preferably in the range described in the above-described drying step.

The heating heater 5 is a heater for drying and solidifying the ink adhering to the recording medium M, that is, a heater for secondary drying. The heating heater 5 can be used in the secondary drying step. The heating heater 5 heats the recording medium M on which an image is recorded, so that moisture and the like contained in the ink are evaporated and scattered more quickly, and an ink film is formed by the resin particles that can be contained in the ink. In this way, the ink film is firmly fixed or adhered on the recording medium M to have excellent film-forming properties, and an excellent high-quality image can be obtained in a short time.

The surface temperature of the recording medium M due to the heating of the heating heater 5 is preferably in the range described in the above-described secondary drying step. When the temperature is within the above range, there is a tendency that a high quality image is obtained in a short time.

The ink jet recording device 1 may include the cooling fan 6. After the ink recorded on the recording medium M is dried, the ink on the recording medium M is cooled by the cooling fan 6, so that an ink coating film can be made on the recording medium M with favorable adhesion property.

In addition, the ink jet recording device 1 may include a preheater 7 that preheats the recording medium M before the ink adheres to the recording medium M. In addition, the ink jet recording device 1 may include the ventilation fan 8 so that the ink adhered to the recording medium M is dried more efficiently.

Below the carriage 9, there are provided the platen 11 that supports the recording medium M, the carriage moving mechanism 13 that moves the carriage 9 relative to the recording medium M, and the transport unit 14 which is a roller that transports the recording medium M in the sub-scanning direction. Operations of the carriage moving mechanism 13 and the transport unit 14 are controlled by the controller CONT.

According to the recording device, since the white ink composition contains the silicone-based surfactant A in which both the surface tension of the aqueous solution with 0.1% by mass of the surfactant and the surface tension of the propylene glycol (PG) solution with 0.1% by mass of the surfactant are 28 mN/m or less, both the droplets of the non-white ink composition in contact with the white ink composition in a state in which the drying has not progressed much after the landing of the white ink composition and the droplets of the non-white ink composition in contact with the white ink composition after the drying has progressed more after the landing of the white ink composition have similar wettability of the droplets of the non-white ink composition, so that an image in which the difference in the image quality of the non-white image is unlikely to occur and the image unevenness is suppressed can be formed.

### 3. Examples and Comparative Examples

Hereinafter, the present disclosure will be described in more detail with reference to Examples and the like, but the present disclosure is not limited to these examples. Hereinafter, “part” and “%” are based on mass unless otherwise specified. Unless otherwise specified, the evaluation was carried out in an environment of a temperature of 25° C. and a relative humidity of 40.0%.

### 3.1. Preparation of White Ink Composition, Non-White Ink Composition, and Treatment Liquid

Each component was put into a container and mixed to have the formulation of Tables 1 and 2, and the mixture was stirred for 2 hours and filtered using a 5.0 μm PTFE-made membrane filter to obtain a white ink composition (W1 to W9), a non-white ink composition (C1), a second ink composition (C2-1 and C2-2), and a treatment liquid (R1 to R6). Numerical values in the tables indicate % by mass. Pure water was used as water, and water was added such that the mass of each composition was 100% by mass. A pigment and a dispersant resin were used by preparing a dispersion liquid described later.

The components other than the compound names in the components shown in Tables 1 and 2 are as follows.
P. B. 15:3: C. I. Pigment Blue 15:3
JONCRYL 631: manufactured by BASF, styrene acrylic resin particles
HYTEC E-6500: product name manufactured by Toho Chemical Industry Co., Ltd., polyethylene wax emulsion
BYK-3420: silicone-based surfactant (manufactured by BYK Japan KK.), satisfying the condition (a)
BYK-3480: silicone-based surfactant (manufactured by BYK Japan KK.), satisfying the condition (a)
SAG503A: Silface SAG503A (manufactured by Nissin Chemical co., ltd.), not satisfying the condition (a)
PD002W: manufactured by Nissin Chemical co., ltd., OLFINE PD002W (acetylene-based surfactant).
1,2-BD: 1,2-butanediol
1,3-BD: 1,3-butanediol
TEG: triethylene glycol
Cationic polymer: “Catiomaster PD-7, polyamine resin (epichlorohydrin-amine derivative resin)” manufactured by Yokkaichi Chemical Company, Limited
1,2-HD: 1,2-hexanediol
PG: propylene glycol
Preparation Example 1: as follows

### Preparation Example 1 of Silicone-Based Surfactant

A silicone-based surfactant was synthesized as Preparation Example 1 by the following synthesis.

5.8 g of a compound having a —H bond bonded to both terminal Si atoms in dimethylpolysiloxane having the number of Si atoms of 19 and 0.1 mL of chloroplatinic acid were added to 20 mL of a tetrahydrofuran solution with 7.0 g of heptaethylene glycol monoallyl ether, and the mixture was held at 65° C. for 24 hours while stirring to be reacted. After the reaction is completed, the solvent was removed by rotary evaporation to obtain a silicone-based surfactant of Preparation Example 1.

A structure of the silicone-based surfactant of Preparation Example 1 was as follows: in Formula (1), a=17, x, y=3, n, m=7, o, p=0, and R¹, R²=hydroxy group.

Measurement conditions of the GPC measurement in each silicone-based surfactant were as follows.

### Measurement Conditions

Solvent: tetrahydrofuran
Column: TSKgel SuperHZM-N×2.
TSKgel guardcolumn SuperHZ-L
Column temperature: 40° C.
Pouring amount: 25 μL
Detector: Differential refraction (RI)
Flow rate: 0.35 mL/min
Calibration curve: Calibration curve using 13 samples of standard polystyrene STKstandard polystyrene (manufactured by Tosoh Corporation) with Mw=1,000,000 up to 500

For each silicone-based surfactant, an aqueous solution with 0.18 by mass of the surfactant and a propylene glycol solution with 0.1% by mass of the surfactant were prepared, and the surface tension thereof was measured in the same manner as described above. The measurement values of each silicone-based surfactant are summarized in Table 6.

In each table, when the silicone-based surfactant satisfied the condition (a) in which the surface tension of the aqueous solution with 0.1% by mass of the surfactant was 28.0 mN/m or less and the surface tension of the propylene glycol solution with 0.1% by mass of the surfactant was 28.0 mN/m or less, it is indicated as “Y”; and when the condition (a) was not satisfied, it is indicated as “N”.

### 3.2. Evaluation Method

### 3.2.1. Evaluation Condition

Printer: modified machine of SC-R5050 (manufactured by Seiko Epson Corporation)
Resolution: 1200×1200 dpi
Adhesion amount (ejection amount): as described in Tables 3 to 5 (mg/inch²)
Number of scanning: 9 times (for each ink)
Surface temperature of recording medium: as described in Tables 3 to 5 (surface temperature of recording medium on platen); the notation of 25 (RT) indicates room temperature without heating by platen.
Drying fan wind speed: wind speed on paper surface, as described in Tables 3 to 5
Post-drying temperature (secondary drying temperature): 80° C.
Recording medium: Orajet 3165G-010
Printing width: width of recording medium

$$64 inch = 162.56 cm$$

$$50 inch = 127 cm$$

$$74 inch = 187.96 cm$$

### 3.2.2. Evaluation of Aggregation (White) (White-Only Pattern)

A solid pattern image of the recorded matter obtained as described above was visually checked, and the presence or absence of bleeding unevenness (aggregation unevenness in which adjacent ink droplets gather) was observed.

Aggregation unevenness was evaluated according to the following evaluation standard.
A: no aggregation (unevenness of density) was observed in the pattern.
B: fine aggregation (unevenness of density) was observed with careful observation.
C: fine aggregation (unevenness of density) was slightly observed.
D: fine aggregation (unevenness of density) was considerably observed.
E: large aggregation (unevenness of density) was observed.

### 3.2.3. Evaluation of Whiteness (White-Only Pattern)

The recorded matter obtained as described above was placed on black paper, ease of viewing the image was visually observed, and visibility was evaluated based on the following evaluation standard. When the adhesion amount of the white ink composition was small, masking properties of the image was not sufficient, blackness of the black paper under the recorded matter was see-through, and the image was difficult to be visually recognized.
A: easily recognized
B: slightly black, but easily recognized
C: black, slightly difficult to recognize
D: black, difficult to recognize

### 3.2.4. Evaluation of Image Unevenness of Color on White (White+Color Pattern)

A solid pattern of the white ink and a solid pattern of the cyan ink were recorded to overlap each other by the above-described recording method. The presence or absence of portions having different degrees of aggregation unevenness of the cyan ink in a width direction of the recording medium in the printed matter was compared.
A: in the printed matter, no difference was confirmed in the aggregation unevenness of the cyan ink by observation with a loupe.
B: in the printed matter, the difference in the aggregation unevenness of the cyan ink was not visible to the naked eye but was visible with a loupe.
C: in the printed matter, the difference in the aggregation unevenness of the cyan ink was slightly visible to the naked eye.
D: in the printed matter, the difference in the aggregation unevenness of the cyan ink was considerably visible to the naked eye.

### 3.2.5. Evaluation of Abrasion Resistance (White+Color Pattern)

A solid portion of the ink was tested. An abrader was made of Kanakin. JSPS test (500 g×30 times) was performed.
A: no color transfer to the abrader and no ground contamination of the printing surface were recognized.
B: color transfer to the abrader was observed, but no ground contamination of the printing surface was recognized.
C: ground contamination of the printing surface was observed, but was not conspicuous.
D: ground contamination of the printing surface was conspicuous.

### 3.2.6. Evaluation of Ejection Stability (White Only)

The recording was performed for 2 hours according to the evaluation conditions. However, the recording was simulated recording in which the ink was not ejected from the head after the recording. After the recording, the nozzle was recovered by suction cleaning, and then the nozzle was inspected. In the cleaning once, 1 cc of the ink was discharged from the nozzle row. The determination was made only for the white ink composition.
A: all nozzles were recovered by cleaning once.
B: all nozzles were recovered by cleaning three times.
C: all nozzles were recovered by cleaning six times.
D: there were nozzles that were not recovered by cleaning six times.

### 3.3. Evaluation Results

From Tables 3 to 5, it was found that all examples in which the white ink composition contained the silicone-based surfactant A and the drying step of drying the white ink composition adhered to the recording medium was performed suppressed the image unevenness of color on white and obtained favorable results. On the other hand, in Comparative Examples 1 and 2 in which the white ink composition did not contain the silicone-based surfactant A, both examples had insufficient image unevenness of color on white. In addition, in Comparative Example 3 and Reference Example 1 in which the drying step of drying the white ink composition adhered to the recording medium was not included, the whiteness of the image formed by the white ink composition was insufficient.

The present disclosure includes a configuration substantially the same as the configuration described in the embodiment, for example, a configuration having the same function, method, and result, or a configuration having the same object and effect. In addition, the present disclosure also includes a configuration in which a non-essential part of the configuration described in the embodiment is replaced. In addition, the present disclosure includes a configuration that exhibits the same effects as the configuration described in the embodiment or a configuration that can achieve the same object. In addition, the present disclosure includes a configuration in which a known technique is added to the configuration described in the embodiment.

The following contents are derived from the above-described embodiments and modification examples.

According to the aspect of the present disclosure, there is provided a recording method of recording on a recording medium using an aqueous white ink composition containing a white color material and an aqueous non-white ink composition containing a non-white color material, the recording method including:
a white ink adhesion step of ejecting the white ink composition from an ink jet head to adhere the white ink composition to the recording medium;
a drying step of drying the white ink composition adhered to the recording medium; and
a non-white ink adhesion step of ejecting the non-white ink composition from an ink jet head to adhere the non-white ink composition to the recording medium, in which
the non-white ink composition is adhered to the white ink composition dried in the drying step in an overlaid manner,
the recording medium is a low-absorptive recording medium or a non-absorptive recording medium,
the white ink adhesion step is performed by main scanning in which a relative position between the ink jet head and the recording medium is moved,
the non-white ink adhesion step is performed by main scanning in which a relative position between the ink jet head and the recording medium is moved, after the main scanning of the white ink adhesion step, and
the white ink composition contains a silicone-based surfactant A in which a surface tension of an aqueous solution with 0.1% by mass of the surfactant is 28.0 mN/m or less and a surface tension of a propylene glycol solution with 0.1% by mass of the surfactant is 28.0 mN/m or less.

According to the recording method, since the white ink composition contains the silicone-based surfactant A in which both the surface tension of the aqueous solution with 0.1% by mass of the surfactant and the surface tension of the propylene glycol (PG) solution with 0.1% by mass of the surfactant are 28 mN/m or less, both the droplets of the non-white ink composition in contact with the white ink composition in a state in which the drying has not progressed much after the landing of the white ink composition and the droplets of the non-white ink composition in contact with the white ink composition after the drying has progressed more after the landing of the white ink composition have similar wettability of the droplets of the non-white ink composition, so that an image in which the difference in the image quality of the non-white image is unlikely to occur and the image unevenness is suppressed can be formed. In addition, by including the drying step, the whiteness (image quality) of the white image can also be improved.

In general, an organic solvent having a standard boiling point higher than that of water is used in the white ink composition in order to impart moisturizing properties. Therefore, after the white ink composition is landed, in a state in which the drying has not progressed, a large amount of water remains; whereas in a state in which the drying has progressed after the landing of the white ink composition, the water evaporates first, and a large amount of the organic solvent remains.

The present inventors have considered that the surface tension of the aqueous solution with 0.1% by mass of the surfactant is related to a surface tension of the white ink composition in a state in which the drying has not progressed after the landing of the white ink composition; and the surface tension of the PG solution with 0.1% by mass of the surfactant is related to a surface tension of the white ink composition in a state in which the drying has progressed after the landing of the white ink composition.

Therefore, it is presumed that the surface tension of the white ink composition in contact with the non-white ink composition affects the wettability of the droplets of the non-white ink composition in contact with the white ink composition, and by setting both of these to be 28 mN/m or less, the unevenness of the image can be reduced. In addition, by using the silicone-based surfactant, the surfactant properties are easily exhibited in both the aqueous solution and the PG solution, and such an effect is easily exhibited.

Furthermore, in the above-described recording method, since the drying step is included, the unevenness of the image formed by the white ink composition is unlikely to occur, but the unevenness of the image formed by the non-white ink composition is likely to occur. However, since the white ink composition contains the above-described silicone-based surfactant A, the unevenness of the image formed by the non-white ink composition can be suppressed.

In the above-described recording method, the surface temperature of the recording medium in the drying step may be 30° C. or higher and 45° C. or lower.

According to the recording method, the unevenness of the image formed by the non-white ink composition can be further suppressed.

In the above-described recording method, the drying step may include a blowing step of blowing air to the white ink composition adhered to the recording medium.

According to the recording method, the effect of suppressing the unevenness of the image formed by the non-white ink composition is more remarkable.

In the above-described recording method, the recording medium may have a recording region where an adhesion amount of the white ink composition is 15 mg/inch² or more.

According to the recording method, the background hiding properties of the image formed by the white ink composition are further improved, and the effect of suppressing the unevenness of the image formed by the non-white ink composition is more remarkable.

In the above-described recording method, the content of the white color material in the white ink composition may be 10% by mass or more and 20% by mass or less.

According to the recording method, the background hiding properties of the image formed by the white ink composition are further improved.

The above-described recording method may further include a treatment liquid adhesion step of adhering a treatment liquid containing an aggregating agent to the recording medium.

According to the recording method, the color development properties of the image formed by the white ink composition are further improved.

In the above-described recording method, the movement lengths of the main scanning in the white ink adhesion step and the non-white ink adhesion step may be each 1 m or more.

According to the recording method, even in a condition in which the difference in landing time is longer and the unevenness of the image formed by the non-white ink composition is likely to occur, the image unevenness can be suppressed.

In the above-described recording method, the white ink composition may contain an organic solvent, and may contain an organic solvent having a standard boiling point of 200° C. or lower in an amount of 50% by mass or more with respect to the total amount of contained organic solvents.

According to the recording method, the abrasion resistance of the white ink composition can be further improved. This effect is more remarkable when the adhesion amount of the white ink composition is large.

In the above-described recording method, the white ink composition may contain an organic solvent, and a standard boiling point of an organic solvent having the highest standard boiling point among contained organic solvents may be 250° C. or lower.

According to the recording method, the abrasion resistance of the white ink composition can be further improved. This effect is particularly remarkable when the adhesion amount of the white ink composition is large.

In the above-described recording method, a direction of first main scanning in the non-white ink adhesion step may be a direction opposite to a direction of last main scanning in the white ink adhesion step on the same main scanning region.

According to the recording method, a condition in which the difference in the landing time is likely to be large and the unevenness of the image formed by the non-white ink composition is likely to occur can be formed, but even in such a case, the image unevenness can be suppressed.

According to the aspect of the present disclosure, there is provided a recording device configured to perform the above-described recording method, the recording device including: the white ink composition; the non-white ink composition; the ink jet head configured to perform the white ink adhesion step; a drying mechanism configured to perform the drying step; and the ink jet head configured to perform the non-white ink adhesion step.

According to the recording device, since the white ink composition contains the silicone-based surfactant A in which both the surface tension of the aqueous solution with 0.1% by mass of the surfactant and the surface tension of the propylene glycol (PG) solution with 0.1% by mass of the surfactant are 28 mN/m or less, both the droplets of the non-white ink composition in contact with the white ink composition in a state in which the drying has not progressed much after the landing of the white ink composition and the droplets of the non-white ink composition in contact with the white ink composition after the drying has progressed more after the landing of the white ink composition have similar wettability of the droplets of the non-white ink composition, so that an image in which the difference in the image quality of the non-white image is unlikely to occur and the image unevenness is suppressed can be formed.

What is claimed is:

1. A recording method of recording on a recording medium using an aqueous white ink composition containing a white color material and an aqueous non-white ink composition containing a non-white color material, the recording method comprising:
ejecting the white ink composition from an ink jet head to adhere the white ink composition to the recording medium;
drying the white ink composition adhered to the recording medium; and
ejecting the non-white ink composition from an ink jet head to adhere the non-white ink composition to the recording medium, wherein
the non-white ink composition is adhered to the dried white ink composition in an overlaid manner,
the recording medium is a low-absorptive recording medium or a non-absorptive recording medium,
the adhesion of white ink is performed by main scanning in which a relative position between the ink jet head and the recording medium is moved,
the adhesion of non-white ink is performed by main scanning in which a relative position between the ink jet head and the recording medium is moved, after the main scanning of the adhesion of white ink, and
the white ink composition contains a silicone-based surfactant A in which a surface tension of an aqueous solution with 0.1% by mass of the surfactant is 28.0 mN/m or less and a surface tension of a propylene glycol solution with 0.1% by mass of the surfactant is 28.0 mN/m or less.

2. The recording method according to claim 1, wherein
a surface temperature of the recording medium in the drying is 30° C. or higher and 45° C. or lower.

3. The recording method according to claim 1, wherein
the drying includes blowing air to the white ink composition adhered to the recording medium.

4. The recording method according to claim 1, wherein
the recording medium has a recording region where an adhesion amount of the white ink composition is 15 mg/inch² or more.

5. The recording method according to claim 1, wherein
a content of the white color material in the white ink composition is 10% by mass or more and 20% by mass or less.

6. The recording method according to claim 1, further comprising:
adhering a treatment liquid containing an aggregating agent to the recording medium.

7. The recording method according to claim 1, wherein
movement lengths of the main scanning in the adhesion of white ink and the adhesion of non-white ink are each 1 m or more.

8. The recording method according to claim 1, wherein
the white ink composition contains an organic solvent, and contains an organic solvent having a standard boiling point of 200° C. or lower in an amount of 50% by mass or more with respect to a total amount of contained organic solvents.

9. The recording method according to claim 1, wherein
the white ink composition contains an organic solvent, and a standard boiling point of an organic solvent having a highest standard boiling point among contained organic solvents is 250° C. or lower.

10. The recording method according to claim 1, wherein
a direction of first main scanning in the adhesion of non-white ink is a direction opposite to a direction of last main scanning in the adhesion of white ink on a same main scanning region.

11. A recording device configured to perform the recording method according to claim 1, the recording device comprising:
the white ink composition;
the non-white ink composition;
the ink jet head configured to perform the adhesion of white ink;
a drying mechanism configured to perform the drying; and
the ink jet head configured to perform the adhesion of non-white ink.
